(19) United States
(12) Patent Application Publication
(10) Pub. No.: US 2025/0039599 A1
(43) Pub. Date: Jan. 30, 2025

(54) WEARABLE DEVICE, SOUND PICKUP METHOD, AND APPARATUS

(71) Applicant: HUAWEI TECHNOLOGIES CO., LTD., Shenzhen (CN)

(72) Inventors: Mengyao ZHU, Shanghai (CN); Chunjian LI, Shanghai (CN); Chaoyu SHI, Shenzhen (CN); Yingming LI, Shanghai (CN); Wen ZHANG, Xi'an (CN); Jingdong CHEN, Xi'an (CN); Xin LENG, Xi'an (CN); Yichen YANG, Xi'an (CN); Xianrui WANG, Xi'an (CN)

(21) Appl. No.: 18/914,149

(22) Filed: Oct. 12, 2024

Related U.S. Application Data
(63) Continuation of application No. PCT/CN2023/087315, filed on Apr. 10, 2023.

(30) Foreign Application Priority Data
Apr. 14, 2022 (CN) 202210393694.4

(51) Int. Cl. H04R 1/40; G10L 21/0216

(52) U.S. Cl. CPC H04R 1/406; G10L 21/0216; G10L 2021/02166; H04R 2410/01; H04R 2420/07; H04R 2430/21; H04R 2499/11

(57) ABSTRACT

This application relates to wearable devices and sound pickup methods. An example method includes: displaying a first interface in response to a first operation, where the first interface is used to configure a sound pickup direction; and determining a target sound pickup direction in response to a second operation detected on the first interface. In some instances, the electronic device can provide a sound pickup direction configuration function by using the first interface, so that a user can select the target sound pickup direction based on an actual application situation, and the electronic device can directly pick up a sound signal based on the target sound pickup direction in a subsequent sound pickup process, or perform signal enhancement processing on a picked-up original sound signal based on the target sound pickup direction to obtain an enhanced sound signal in the target sound pickup direction in the original sound signal.

### CROSS REFERENCE TO RELATED APPLICATIONS

This application is a continuation of International Application No. PCT/CN2023/087315, filed Apr. 10, 2023, which claims priority to Chinese Patent Application No. 202210393694.4, filed Apr. 14, 2022. The disclosures of the aforementioned applications are hereby incorporated by reference in their entireties.

### TECHNICAL FIELD

This application relates to the field of terminal technologies, and in particular, to a wearable device, a sound pickup method, and an apparatus.

### BACKGROUND

With continuous progress of science and technology, wearable devices (such as a headset, smart glasses, and a smart band) have become an indispensable part of people's daily life. A microphone array is added to the wearable device, so that the wearable device has a sound pickup function. Currently, the microphone array in the wearable device usually includes two omnidirectional microphones. The two omnidirectional microphones in the wearable device are disposed as close as possible to be in a straight line with the mouth of a wearer, so that a sound signal of the wearer is obtained based on a principle of sound signal superposition, and then the obtained sound signal of the wearer is processed based on a differential array (Differential Microphone Array, DMA) algorithm, to improve quality of the sound signal that is of the wearer and that is picked up by the wearable device.

In this case, when the microphone array is not effectively installed in the wearable device, or when the wearer uses the wearable device in a relatively noisy environment, an audio signal mixed with a human voice and ambient noise is simultaneously collected by the microphones in the wearable device. It is likely to reduce intelligibility of the sound signal picked up by the wearable device, affect sound pickup quality, and reduce a signal-to-noise ratio.

### SUMMARY

This application provides a wearable device, a sound pickup method, and an apparatus, to resolve problems of a picked-up sound signal to some extent, such as low intelligibility, poor sound pickup quality, and a low signal-to-noise ratio.

To achieve the foregoing purpose, the following technical solutions are used in this application.

According to a first aspect, this application provides a wearable device. The wearable device includes a microphone array, and the microphone array includes at least one directional microphone. Directions of sound pickup beams of the at least one directional microphone are orthogonal to each other.

The wearable device provided in this application is configured with the microphone array that includes the at least one directional microphone. The at least one directional microphone in the microphone array is used to pick up a sound signal, and a characteristic that the directional microphone is sensitive to a sound signal in a specific direction is fully utilized to collect the sound signal. This can reduce noise mixed in the sound signal from a source of obtaining a sound, effectively avoid degradation of sound signal quality due to collection of an excessively complex sound signal, improve sound quality of the obtained sound signal, and improve a signal-to-noise ratio.

In addition, when the directions of the sound pickup beams of the at least one directional microphone are orthogonal to each other, the microphone may obtain sound signals in a plurality of different directions. Diversified processing may be further performed on the obtained sound signals based on the obtained sound signals. This enhances sound pickup performance of the microphone, and further enhances overall performance of the wearable device and improves user experience.

In a possible implementation of the first aspect, the microphone array further includes at least one omnidirectional microphone.

In this possible implementation, when the microphone array further includes the omnidirectional microphone, the sound may be evenly picked up from all directions by using the omnidirectional microphone, to obtain diverse and wide-range audio signals or noise. Based on different actual application requirements, noise reduction and enhancement processing may be performed, by using the audio signals or the noise obtained by the omnidirectional microphone, on the audio signal collected by the directional microphone. This improves sound pickup quality of the directional microphone, and further enhances sound pickup performance of the wearable device.

In a possible implementation of the first aspect, the wearable device is configured to: when a target sound pickup direction is detected by the wearable device, enable a microphone that is in the microphone array and that points to the target sound pickup direction, and disable a microphone that is in the microphone array and that does not point to the target sound pickup direction.

In this possible implementation, in an actual application process, power consumption of the wearable device can be reduced, user experience is improved, and a service life of the wearable device is prolonged. In addition, the wearable device enables, based on the detected target sound pickup direction, the microphone that points to the target sound pickup direction, and disables another microphone. This can prevent, as much as possible, the microphone from picking up noise in a direction other than the target sound pickup direction, and enhance sound pickup effect.

In a possible implementation of the first aspect, the wearable device is configured to: when it is detected that a first directional microphone that meets a preset condition exists in the microphone array, enable the first directional microphone, and disable another directional microphone, where the preset condition is that signal quality of a sound signal picked up by the first directional microphone is higher than signal quality of a sound signal picked up by the another directional microphone in a preset time period.

In this possible implementation, power consumption of the wearable device can be reduced, user experience is improved, and a service life of the wearable device is prolonged. In addition, the wearable device enables, based on the preset condition, the first directional microphone that meets the first preset condition, and disables the another microphone. This can prevent, as much as possible, the microphone from picking up a sound signal in another direction that does not meet the preset condition, and enhance sound pickup effect.

In a possible implementation of the first aspect, the wearable device is smart glasses.

In a possible implementation of the first aspect, when the microphone array includes one omnidirectional microphone, the omnidirectional microphone is located in a bridge or a nose pad of a rim of the smart glasses.

In a possible implementation of the first aspect, when the microphone array includes two omnidirectional microphones, the two omnidirectional microphones are respectively located on two temples of the smart glasses, or the two omnidirectional microphones are respectively located in positions that are on two sides of rims of the smart glasses and that are close to two temples.

In a possible implementation of the first aspect, when the microphone array includes a plurality of omnidirectional microphones, the plurality of omnidirectional microphones are distributed in a middle area and two side areas of the smart glasses, the middle area includes a bridge and/or nose pads of rims of the smart glasses, and the two side areas include two temples of the smart glasses and/or positions that are on two sides of the rims of the smart glasses and that are close to the two temples.

Based on the foregoing several possible implementations, positions of omnidirectional microphones are set based on a quantity of omnidirectional microphones, so that the omnidirectional microphones in the microphone array can evenly pick up the sound from as many directions as possible, to obtain diverse and wide-range audio signals or noise. Based on different actual application requirements, noise reduction and enhancement processing may be performed, by using the audio signals or noise obtained by the omnidirectional microphone, on the audio signal collected by the directional microphone. This improves sound pickup quality of the directional microphone, and further enhances sound pickup performance of the smart glasses.

In a possible implementation of the first aspect, the directional microphone is a figure-8 microphone.

In this possible implementation, when the figure-8 directional microphone is used in the microphone array in the wearable device, utilization of the figure-8 microphone can be fully improved, production, manufacturing, and research and development costs of the wearable device can be reduced, and a manufacturing rate of the wearable device can be improved.

According to a second aspect, this application provides a sound pickup method, applied to an electronic device. The method includes:
displaying a first interface in response to a first operation, where the first interface is used to configure a sound pickup direction; and
determining a target sound pickup direction in response to a second operation detected on the first interface.

According to the sound pickup method provided in this application, the electronic device can provide a sound pickup direction configuration function by using the first interface, so that a user can select the target sound pickup direction based on an actual application situation, and the electronic device can directly pick up a sound signal based on the target sound pickup direction in a subsequent sound pickup process, or perform signal enhancement processing on a picked-up original sound signal based on the target sound pickup direction to obtain an enhanced sound signal in the target sound pickup direction in the original sound signal. This effectively improves a signal-to-noise ratio of the finally picked-up sound signal, and improves intelligibility of the sound signal and user experience.

In a possible implementation of the second aspect, the method provided in this embodiment of this application further includes:
obtaining an original sound signal; and
performing enhancement processing on the original sound signal based on the target sound pickup direction to obtain an enhanced sound signal of a first sound signal in the target sound pickup direction in the original sound signal.

In this possible implementation, after the original sound signal is obtained, enhancement processing is performed on the original sound signal based on the target sound pickup direction, to obtain the enhanced sound signal corresponding to the target sound pickup direction. In this way, the target sound pickup direction may be flexibly adjusted based on different actual application scenarios, to obtain, through enhancement processing, the enhanced sound signal corresponding to the target sound pickup direction. In this case, the obtained sound signal does not mix with another omnidirectional sound signal, clarity of a sound used for play is improved, and sound quality of the sound signal is improved.

In a possible implementation of the second aspect, the obtaining an original sound signal includes:
obtaining the original sound signal in a sound recording process; and
after the performing enhancement processing on the original sound signal based on the target sound pickup direction to obtain an enhanced sound signal of a first sound signal in the target sound pickup direction in the original sound signal, the method further includes: saving the enhanced sound signal.

In this possible implementation, for a sound recording scenario, the sound signal subsequently heard by a user is the enhanced sound signal obtained through enhancement processing. Therefore, it is convenient for the user to repeatedly hear a sound signal with relatively high sound quality subsequently. This resolves a problem that intelligibility of the sound signal is reduced because a sound signal other than a to-be-recorded sound signal is collected in a sound recording process. This improves a signal-to-noise ratio of the obtained sound signal, and improves intelligibility of the picked-up sound signal.

In a possible implementation of the second aspect, the obtaining an original sound signal includes:
obtaining the original sound signal in a call process; and
after the performing enhancement processing on the original sound signal based on the target sound pickup direction to obtain an enhanced sound signal of a first sound signal in the target sound pickup direction in the original sound signal, the method further includes: sending the enhanced sound signal to a calling end device.

In this possible implementation, a call scenario includes a voice call, a video call, a conference call, and the like. In the call scenario, two parties in a call can hear the enhanced sound signal obtained through enhancement processing. This resolves a problem that intelligibility of the sound signal is reduced because audio or noise other than a sound signal between the two parties in the call is collected in a call process. This improves a signal-to-noise ratio of the obtained sound signal, improves intelligibility of the picked-up sound signal, and improves communication efficiency between the two parties.

In a possible implementation of the second aspect, the original sound signal is a sound signal in a recorded original video, and after the performing enhancement processing on the original sound signal based on the target sound pickup direction to obtain an enhanced sound signal of a first sound signal in the target sound pickup direction in the original sound signal, the method further includes: replacing the original sound signal in the original video with the enhanced sound signal.

In this possible implementation, for a video recording scenario, after the original sound signal in an original video is replaced with the enhanced sound signal, sound quality of a sound in a recorded video is greatly improved. This resolves a problem that intelligibility of the sound signal is reduced because the sound signal mixed with different audio signals and environmental noise is collected in the recorded original video. This improves a signal-to-noise ratio of the obtained sound signal, and improves intelligibility of the picked-up sound signal.

In a possible implementation of the second aspect, the obtaining an original sound signal further includes: receiving the original sound signal sent by a sound pickup device. In this way, based on mutual cooperation between different devices, it is possible to obtain the original sound signal in all scenarios, and this helps prolong a service life of the microphone.

In a possible implementation of the second aspect, the method provided in this embodiment of this application further includes: sending the target sound pickup direction to the sound pickup device. This can reduce a processing burden of a processor of the electronic device, and effectively ensure normal and stable operation of electronic device. In addition, the sound pickup device may pick up, based on the received target sound pickup direction, a sound signal corresponding to the target sound pickup direction, to obtain a sound signal with higher clarity, higher intelligibility, and a higher signal-to-noise ratio.

In a possible implementation of the second aspect, the electronic device includes a microphone array, the microphone array includes at least one directional microphone, and that the electronic device obtains an original sound signal includes:
enabling, based on the target sound pickup direction, a directional microphone that points to the target sound pickup direction, and disabling a directional microphone that does not point to the target sound pickup direction; and
collecting the original sound signal by using the enabled directional microphone that points to the target sound pickup direction.

In this possible implementation, power consumption of the electronic device can be reduced, user experience is improved, and a service life of smart glasses is prolonged. In addition, the electronic device enables, based on the detected target sound pickup direction, the microphone that points to the target sound pickup direction, and disables another microphone. This can further prevent, as much as possible, the microphone from picking up noise in a direction other than the target sound pickup direction, and enhance sound pickup effect of the microphone. In actual application, different sound pickup effect can be further implemented by using an enabled state or a disabled state of each directional microphone.

In a possible implementation of the second aspect, the obtaining an original sound signal includes: enabling, based on the target sound pickup direction, a directional microphone that points to the target sound pickup direction, and disabling a directional microphone that does not point to the target sound pickup direction;
collecting the original sound signal by using the enabled directional microphone that points to the target sound pickup direction; and
performing enhancement processing on the original sound signal based on the target sound pickup direction to obtain an enhanced sound signal of a first sound signal in the target sound pickup direction in the original sound signal.

In this possible implementation, the electronic device enables, based on the target sound pickup direction, the microphone that points to the target sound pickup direction, and disables another microphone. This can prevent the microphone from picking up noise in a direction other than the target sound pickup direction, reduce obtained noise with relatively strong sound quality in the original sound signal, and enhance sound pickup effect of the microphone. Further, enhancement processing is performed on the sound signal obtained by the enabled directional microphone, to obtain the enhanced sound signal corresponding to the target sound pickup direction. In this case, the obtained sound signal does not mix with a sound signal in another direction, and clarity and sound quality of the enhanced sound signal are improved. This effectively improves a signal-to-noise ratio of the finally picked-up sound signal, and improves intelligibility of the sound signal and user experience.

In a possible implementation of the second aspect, the method provided in this embodiment of this application further includes: sending the enhanced sound signal to an audio playing device. This expands a component for playing the enhanced sound signal, allowing the enhanced sound signal for playing to adapt to different usage scenarios.

In a possible implementation of the second aspect, the method provided in this embodiment of this application further includes: playing the enhanced sound signal. This helps directly hear the enhanced sound signal.

In a possible implementation of the second aspect, before the displaying a first interface in response to a first operation, the method provided in this embodiment of this application further includes:
displaying a sound recording interface, where a sound pickup configuration key is displayed on the sound recording interface; and
detecting a first operation on the sound recording interface, where the first operation is a trigger operation of the sound pickup configuration key.

In a possible implementation of the second aspect, the first operation is a sound recording start operation, and the method provided in this embodiment of this application further includes:
enabling a sound recording function in response to the first operation.

In a possible implementation of the second aspect, before the displaying a first interface in response to a first operation, the method provided in this embodiment of this application further includes:
displaying a call screen, where a sound pickup configuration key is displayed on the call screen; and
detecting a first operation on the call screen, where the first operation is a trigger operation of the sound pickup configuration key.

In a possible implementation of the second aspect, the first operation is a call establishment operation, and the method provided in this embodiment of this application further includes:
enabling a function of establishing a voice call or video call in response to the first operation.

In a possible implementation of the second aspect, before the displaying a first interface in response to a first operation, the method provided in this embodiment of this application further includes:
displaying a video recording interface, where a sound pickup configuration key is displayed on the video recording interface; and
detecting a first operation on the video recording interface, where the first operation is a trigger operation of the sound pickup configuration key.

In a possible implementation of the second aspect, the first operation is a video recording start operation, and the method provided in this embodiment of this application further includes:
enabling a video recording function in response to the first operation.

In a possible implementation of the second aspect, before the displaying a first interface in response to a first operation, the method provided in this embodiment of this application further includes:
displaying a conference interface, where a sound pickup configuration key is displayed on the conference interface; and
detecting a first operation on the conference interface, where the first operation is a trigger operation of the sound pickup configuration key.

In a possible implementation of the second aspect, the first operation is an operation of starting a conference mode, and the method provided in this embodiment of this application further includes: enabling a conference function in response to the first operation.

Before the displaying a first interface in response to a first operation, the method provided in this embodiment of this application further includes:
displaying a sound pickup scenario setting interface; and
enabling or disabling a display scenario of the first interface in response to a second operation detected on the sound pickup scenario setting interface, where the display scenario includes at least one of a sound recording scenario, a call scenario, a video recording scenario, and a conference scenario.

According to a third aspect, this application provides a sound pickup method, applied to a sound pickup device. The method includes:
receiving a target sound pickup direction sent by an electronic device; and
obtaining a target sound signal in the target sound pickup direction.

According to the sound pickup method provided in this application, after the sound pickup device receives the target sound pickup direction sent by the electronic device, the sound pickup device can directly pick up a target sound signal based on the target sound pickup direction in a subsequent sound pickup process, or perform signal enhancement processing on a picked-up original sound signal based on the target sound pickup direction to obtain a target sound signal in the target sound pickup direction in the original sound signal. This effectively improves a signal-to-noise ratio of the finally picked-up sound signal, and improves intelligibility of the sound signal and user experience.

In a possible implementation of the third aspect, the obtaining a target sound signal in the target sound pickup includes:
collecting an original sound signal; and
performing enhancement processing on the original sound signal based on the target sound pickup direction to obtain an enhanced sound signal of a first sound signal in the target sound pickup direction in the original sound signal, where the enhanced sound signal is the target sound signal.

In this possible implementation, after the original sound signal is obtained, enhancement processing is performed on the original sound signal based on the target sound pickup direction, to obtain the enhanced sound signal corresponding to the target sound pickup direction. In this way, the target sound pickup direction may be flexibly adjusted based on different actual application scenarios, to obtain, through enhancement processing, the enhanced sound signal corresponding to the target sound pickup direction. In this case, the obtained sound signal does not mix with another omnidirectional sound signal, clarity of the target sound signal is improved, and sound quality of the target sound signal is improved.

In a possible implementation of the third aspect, the obtaining a target sound signal in the target sound pickup includes:
enabling, based on the target sound pickup direction, the microphone that points to the target sound pickup direction, and disabling the microphone that does not point to the target sound pickup direction; and
collecting the target sound signal by using the enabled microphone that points to the target sound pickup direction.

In this possible implementation, based on the detected target sound pickup direction, the microphone that points to the target sound pickup direction is enabled, and another microphone is disabled. This can prevent the microphone from picking up noise in a direction other than the target sound pickup direction, reduce obtained noise with relatively strong sound quality in the original sound signal, and enhance sound pickup effect of the microphone. In addition, this can effectively avoid great power consumption caused by operation of an unrelated microphone, and prolong a service life of the sound pickup device.

In a possible implementation of the third aspect, the obtaining a sound signal in the target sound pickup includes:
enabling, based on the target sound pickup direction, the microphone that points to the target sound pickup direction, and disabling the microphone that does not point to the target sound pickup direction; and
collecting an original sound signal by using the enabled microphone that points to the target sound pickup direction; and
performing enhancement processing on the original sound signal based on the target sound pickup direction to obtain an enhanced sound signal of a first sound signal in the target sound pickup direction in the original sound signal, where the enhanced sound signal is the target sound signal.

In this possible implementation, the sound pickup device enables, based on the target sound pickup direction, the microphone that points to the target sound pickup direction, and disables another microphone. This can prevent the microphone from picking up noise in a direction other than the target sound pickup direction, reduce obtained noise with relatively strong sound quality in the original sound signal, and enhance sound pickup effect of the microphone. Further, enhancement processing is performed on the sound signal obtained by the enabled directional microphone, to obtain the enhanced sound signal corresponding to the target sound pickup direction. In this case, the obtained sound signal does not mix with a sound signal in another direction, and clarity and sound quality of the enhanced sound signal are improved. This effectively improves a signal-to-noise ratio of the finally picked-up sound signal, and improves intelligibility of the sound signal and user experience.

In a possible implementation of the third aspect, the method provided in this embodiment of this application further includes: playing the target sound signal.

In a possible implementation of the third aspect, the method provided in this embodiment of this application further includes: sending the target sound signal to an audio playing device. This expands a device for playing the target sound signal, and enriches an actual application scenario.

According to a fourth aspect, this application provides a chip system. The chip system includes a processor, and the processor executes a computer program stored in a memory, to perform the method according to any one of the second aspect or the third aspect.

In a possible implementation of the fourth aspect, the chip system further includes the memory, and the memory is connected to the processor through a circuit or a line.

According to a fifth aspect, this application provides an electronic device, including a processor. The processor is configured to run a computer program stored in a memory, to perform the method according to any one of the second aspect or any possible implementation of the second aspect.

In a possible implementation of the fifth aspect, the electronic device is the wearable device according to the first aspect or any optional manner of the first aspect.

According to a sixth aspect, this application provides a sound pickup device, including a processor. The processor is configured to run a computer program stored in a memory, to perform the method according to any one of the third aspect or any possible implementation of the third aspect.

In a possible implementation of the sixth aspect, the sound pickup device is the wearable device according to the first aspect or any optional manner of the first aspect.

According to a seventh aspect, this application provides a computer-readable storage medium. The computer-readable storage medium stores a computer program, and when the computer program is executed by a processor, the method according to any one of the second aspect or the third aspect is performed.

According to an eighth aspect, an embodiment of this application provides a computer program product. When the computer program product is run on an electronic device or a sound pickup device, the electronic device is enabled to perform the method according to any one of the second aspect or the third aspect.

For technical effects of the fourth aspect to the eighth aspect provided in this application, refer to the technical effects of optional manners of the first aspect, the second aspect, or the third aspect. Details are not described herein again.

### BRIEF DESCRIPTION OF DRAWINGS

FIG. 1 is a diagram of a partial structure of smart glasses according to an embodiment of this application;

FIG. 2 is a diagram of a structure of a headset according to an embodiment of this application;

FIG. 3 is a diagram of a usage scenario in which smart glasses are used as a wearable device according to an embodiment of this application;

FIG. 4 is a diagram of sensitivity of a figure-8 directional microphone to a sound signal according to an embodiment of this application;

FIG. 5 is a diagram of sensitivity of an omnidirectional microphone to a sound signal according to an embodiment of this application;

FIG. 6 is a functional block diagram of a system including a wearable device and an electronic device according to an embodiment of this application;

FIG. 7 to FIG. 18 are diagrams in which different microphone array structures in smart glasses form beams according to an embodiment of this application;

FIG. 19 is a diagram of a sound pickup method according to an embodiment of this application;

FIG. 20(a) and FIG. 20(b) to FIG. 26 are related diagrams of different scenarios of displaying a first interface according to an embodiment of this application;

FIG. 27 and FIG. 28 are diagrams of displaying a first interface according to an embodiment of this application;

FIG. 29 is a diagram of a plurality of gestures according to an embodiment of this application;

FIG. 30 is a schematic flowchart of a noise reduction and extraction process of a sound signal according to an embodiment of this application;

FIG. 31 is a diagram of performing spatial feature clustering on a sound signal according to an embodiment of this application;

FIG. 32 and FIG. 33 are schematic flowcharts of another noise reduction and extraction process of a sound signal according to an embodiment of this application;

FIG. 34 is a diagram of comparison of effect of extracting a sound signal of a wearer in a same noise environment according to an embodiment of this application;

FIG. 35 is a diagram of an interaction process of a sound pickup method according to an embodiment of this application;

FIG. 36 is a diagram of an interface for connecting an electronic device to a sound pickup device according to an embodiment of this application;

FIG. 37 is a diagram of an interaction process of another sound pickup method according to an embodiment of this application;

FIG. 38 is a diagram of a structure of an electronic device according to an embodiment of this application; and

FIG. 39 is a diagram of a software structure of an electronic device according to an embodiment of this application.

### DESCRIPTION OF EMBODIMENTS

The following describes the technical solutions in embodiments of this application with reference to accompanying drawings and related embodiments in embodiments of this application. In the descriptions of embodiments of this application, terms used in the following embodiments are merely intended to describe purposes of specific embodiments, but are not intended to limit this application. The terms “one”, “the”, “the foregoing”, “this”, and “the one” of singular forms used in this specification and the appended claims of this application are also intended to include expressions such as “one or more”, unless otherwise specified in the context clearly. It should be further understood that in the following embodiments of this application, “at least one” and “one or more” mean one or at least two (including two). The term “and/or” is used to describe an association relationship between associated objects and indicates that three relationships may exist. For example, A and/or B may indicate the following cases: Only A exists, both A and B exist, and only B exists, where A and B each may be singular or plural. The character “/” generally indicates an “or” relationship between the associated objects.

Reference to “an embodiment”, “some embodiments”, or the like described in this specification indicates that one or more embodiments of this application include a specific feature, structure, or characteristic described with reference to the embodiments. Therefore, statements such as “in an embodiment”, “in some embodiments”, “in some other embodiments”, and “in other embodiments” that appear at different places in this specification do not necessarily mean reference to a same embodiment. Instead, the statements mean “one or more but not all of embodiments”, unless otherwise specifically emphasized in another manner. The terms “include”, “comprise”, “have”, and their variants all mean “include but are not limited to”, unless otherwise specifically emphasized in another manner. The term “connection” includes a direct connection and an indirect connection, unless otherwise stated. “First” and “second” are merely intended for a purpose of description, and shall not be understood as an indication or implication of relative importance or implicit indication of a quantity of indicated technical features.

In embodiments of this application, the word “example”, “for example”, or the like is used to indicate giving an example, an illustration, or a description. Any embodiment or design scheme described as “example” or “for example” in embodiments of this application should not be explained as being more preferred or having more advantages than another embodiment or design scheme. Exactly, use of the word “example”, “for example”, or the like is intended to present a relative concept in a specific manner.

With continuous progress of science and technology, wearable devices (such as a headset, smart glasses, and a smart band) have become an indispensable part of people's daily life. A microphone array is added to the wearable device, so that the wearable device has a sound pickup function. Currently, the microphone array in the wearable device usually includes two omnidirectional microphones. The two omnidirectional microphones in the wearable device are disposed as close as possible to be in a straight line with the mouth of a wearer, so that a sound signal of the wearer is obtained based on a principle of sound signal superposition, and then the obtained sound signal of the wearer is processed based on a differential array (Differential Microphone Array, DMA) algorithm, to improve quality of the sound signal that is of the wearer and that is picked up by the wearable device.

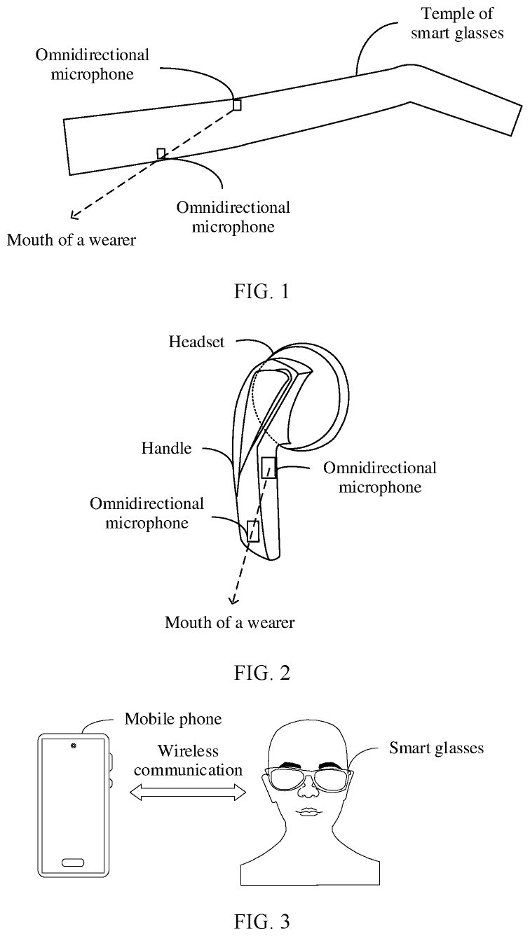

For example, FIG. 1 is a diagram of a partial structure of smart glasses. Refer to FIG. 1. Two omnidirectional microphones are disposed on temples of the smart glasses. The two omnidirectional microphones in the smart glasses are approximately disposed in a straight line with the mouth of a wearer of the smart glasses. After the wearer wears the smart glasses, when the wearer emits a sound signal from the mouth, the sound signal may be collected by using the two omnidirectional microphones in the smart glasses.

For another example, FIG. 2 is a diagram of a structure of a headset. Refer to FIG. 2. Two omnidirectional microphones are disposed in a handle of the headset. The two omnidirectional microphones in the headset are approximately disposed in a straight line with the mouth of a wearer of the headset. After the wearer wears the headset, when the wearer emits a sound signal from the mouth, the sound signal may be collected by using the two omnidirectional microphones disposed in the handle of the headset.

In the foregoing example, the differential array (Differential Microphone Array, DMA) algorithm is usually used to further process the sound signal picked up by the microphone array, to obtain the processed sound signal. The DMA mainly processes the sound signal by using a difference in spatial sound pressure. Specifically, when N microphones are disposed in a sound pickup device, an (N−1)^{th}-order difference may be obtained, and then the sound signal is processed by using the (N−1)^{th}-order difference. When the microphone array in the sound pickup device includes two microphones, a first-order differential beam of the sound signal may be obtained by using the DMA, that is, a difference between the sound signal collected by the microphone and a noise signal collected by the microphone is calculated to extract the sound signal.

In the foregoing conventional technology, quality of the sound signal that is of the wearer and that is picked up by the wearable device needs to be improved by using a special manner of disposing the two omnidirectional microphones in the microphone array in the wearable device and by using the DMA method. However, if the omnidirectional microphones in the microphone array in the wearable device are not disposed in the straight line with the mouth of the wearer, that is, when there is a relatively large deviation, the quality of the picked-up sound signal is reduced, a signal-to-noise ratio is reduced, and user experience is affected.

In addition, if the wearable device is used in a relatively noisy sound pickup environment, a sound signal mixed with a human voice and ambient noise is simultaneously collected by the microphone array in the wearable device. When the sound signal picked up by the microphone array is processed by using the foregoing method, the noise signal in the sound signal collected by the microphone cannot be screened out. As a result, intelligibility of the processed sound signal is reduced, and sound pickup quality is affected.

Therefore, for the problems of low intelligibility, poor sound pickup quality, and a relatively low signal-to-noise ratio of the sound signal picked up in the wearable device, this application provides a wearable device. The wearable device is disposed with a microphone array that includes at least one directional microphone. The at least one directional microphone in the microphone array is used to pick up a sound signal, and a characteristic that the directional microphone is sensitive to a sound signal in a specific direction is fully utilized to collect the sound signal. This can reduce noise mixed in the sound signal from a source of obtaining a sound, effectively avoid degradation of sound signal quality due to collection of an excessively complex sound signal, eliminate an installation constraint on the microphone array in the wearable device, improve sound quality of the obtained sound signal, and improve a signal-to-noise ratio.

The wearable device provided in an embodiment of this application may be a device having a sound pickup function, like smart glasses, an augmented reality (AR)/virtual reality (VR)/mixed reality (MR) device, a smart helmet, a headphone, a hearing aid device, an in-ear earphone, an earbud, a smart band (smart wristband), a smart watch, a pedometer, a two-way radio, or a recording pen. It is not difficult to understand that the wearable device may be another future technology-oriented device.

The wearable device may be used in a plurality of scenarios. For example, the scenarios include but are not limited to a video call scenario, a voice call scenario, a professional sound recording scenario, a radio/broadcast/hosting scenario, a live game/live commerce scenario, a conference scenario, and another scenario to which a sound pickup function can be applied. Further, the call scenario may include an indoor call scenario, an outdoor call scenario, a quiet/noisy call scenario, a cycling/running/sport call scenario, an in-vehicle call scenario, a single-ear call scenario, a dual-ear call scenario, a remote conference call scenario, and the like.

To more conveniently describe the wearable device provided in this embodiment of this application, as an example rather than a limitation, the following describes in detail the technical solutions of this application by using smart glasses as the wearable device.

FIG. 3 is a diagram of a usage scenario in which smart glasses are used as a wearable device according to an embodiment of this application. Refer to FIG. 3. The smart glasses may be worn over eyes of a user, to implement a function of wireless communication with an electronic device (for example, a mobile phone). In this embodiment of this application, the smart glasses include a microphone array, and the microphone array includes at least one directional microphone.

Based on an actual application requirement, a quantity of directional microphones in the microphone array may be flexibly set. For example, if sound signals in a plurality of directions need to be collected, a plurality of directional microphones may be disposed in the wearable device. If there are at least two directional microphones in the microphone array, diversified processing may be further performed on an obtained sound signal. This enhances sound pickup performance of the microphone, and further enhances overall performance of the wearable device and improves user experience. The quantity of directional microphones in the microphone array may be set based on an actual application requirement. This is not limited in this application.

In a possible implementation, directions of sound pickup beams of the at least one directional microphone in the microphone array are orthogonal to each other. That the directions of the sound pickup beams of the directional microphone are orthogonal to each other means that sound pickup directions corresponding to the directional microphones in the microphone array are perpendicular to each other.

It should be understood that, to preserve as many sound features as possible in a sound signal collected by the microphone, the sound pickup direction of the directional microphone in the microphone array may point to a preset sound source position. For example, the sound pickup direction of the directional microphone in the microphone array in the smart glasses may point to the mouth of a wearer wearing the smart glasses. Alternatively, for a hearing aid device, a sound pickup direction of a directional microphone in a microphone array in the hearing aid device may point to another direction, to better pick up a sound signal of another person engaged in a conversation with a wearer wearing the hearing aid device. Different wearable devices may have different preset sound source positions. This is not limited in this application.

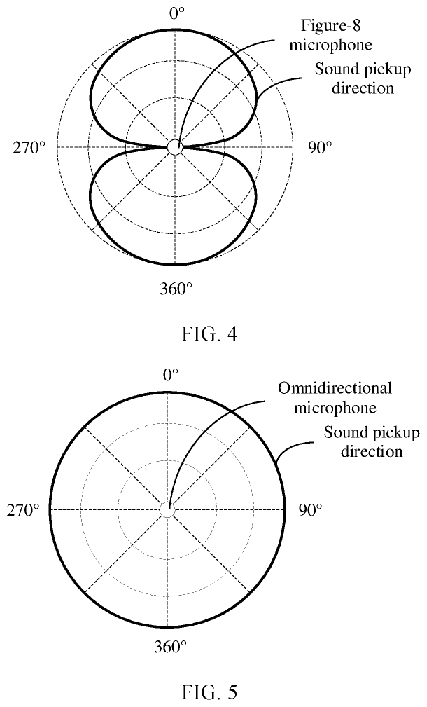

In another possible implementation, the directional microphone may be a figure-8 microphone. FIG. 4 is a diagram of sensitivity of the figure-8 directional microphone to a sound signal. The figure-8 microphone is also called a bidirectional microphone, and is mainly sensitive to two sound signals in opposite directions. When the figure-8 directional microphone is used in the microphone array in the wearable device, utilization of the figure-8 microphone can be fully improved, production, manufacturing, and research and development costs of the wearable device can be reduced, and a manufacturing rate of the wearable device can be improved.

Optionally, the microphone array may further include an omnidirectional microphone. FIG. 5 is a diagram of sensitivity of the omnidirectional microphone to a sound signal. As shown by bold line segments in FIG. 5, the omnidirectional microphone has same sensitivity to sound signals from all angles. In this embodiment of this application, when the microphone array includes the omnidirectional microphone and the directional microphone, sounds may be evenly picked up from all directions by using the omnidirectional microphone, to obtain diverse and wide-range audio signals or noise. Based on different actual application requirements, noise reduction and enhancement processing may be performed, by using the audio signals or the noise obtained by the omnidirectional microphone, on an audio signal collected by the directional microphone. This improves sound pickup quality of the directional microphone, and further enhances sound pickup performance of the wearable device.

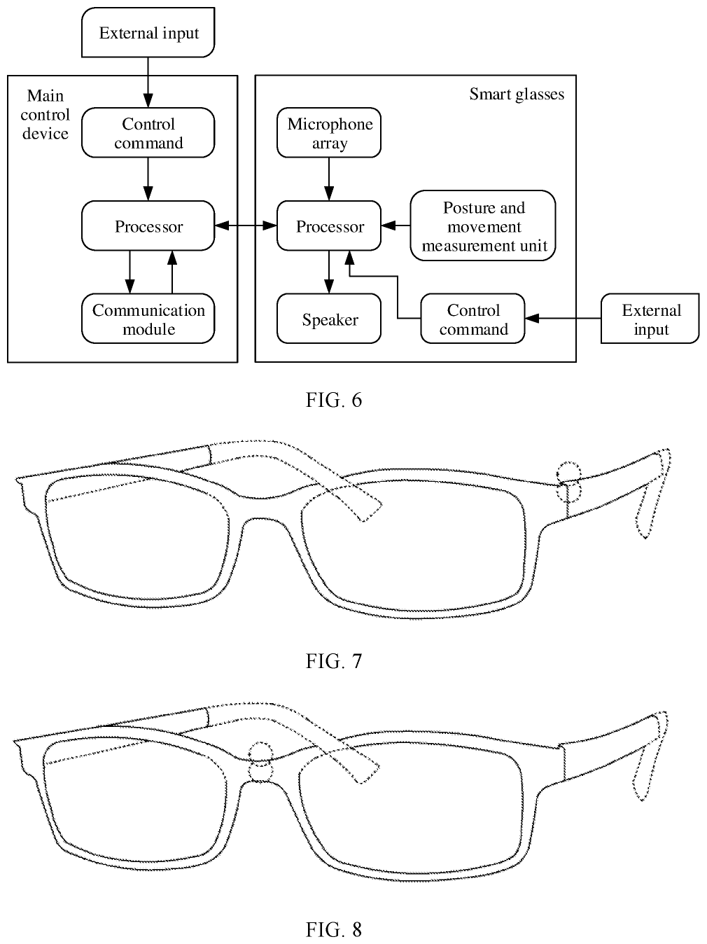

Based on this embodiment, in addition to the microphone array, the smart glasses may further include a speaker and a processor as shown in FIG. 6. Further, the speaker is a component that is close to a left/right ear of the wearer and that may be used for independent play. The speaker may be disposed in temples on two sides of the smart glasses, and is configured to play a sound to the ears of the wear. The speaker may be an external speaker, for example, a loudspeaker or a stereo, or may be a speaker that is close to the ear for play. The processor is configured to process the sound signal, or distribute the sound signal collected by the microphone array to a processor of the electronic device, so that the processor of the electronic device processes the sound signal in a timely manner. Certainly, in actual application, the smart glasses may further include a communication module and a control interface. The communication module is configured for communication between the smart glasses and another electronic device, and the control interface is used to control the smart glasses.

It is not difficult to understand that the electronic device is also referred to as a main control device. After a communication connection between the main control device and the smart glasses succeeds, the main control device may control the smart glasses. The processor of the main control device may be configured to process the sound signal distributed by the processor of the smart glasses, and a communication module of the main control device may implement interactive communication with the smart glasses by using the communication module of the smart glasses.

It should be understood that the control interface of the smart glasses and/or a control interface of the main control device may receive an externally input control command, to control the smart glasses and/or the main control device by using the received control command. A manner of receiving the control command includes but is not limited to using a physical button on the smart glasses or the main control device, or a touch gesture or a mid-air gesture on the smart glasses or the main control device. For example, for volume adjustment of audio and a video in the smart glasses, a volume adjustment control command may be received by using the physical button on the smart glasses, or received by using the touch gesture received by the main control device (for example, a mobile phone).

To enhance user experience, optionally, a posture and movement measurement unit is further disposed in the wearable device. The posture and movement measurement unit is configured to track different posture changes of the wearer after the wearer wears the device and distribute tracking data to the processor. In an actual application process, after the user wears the wearable device, a relative position or direction between the wearable device and the user changes with head/wrist movement of the user. For example, the wearer wears the smart glasses, and A is located in front of the wearer. When positions of the wearer and A remain unchanged, a sound signal of Ain front of the wearer may be enhanced, and the enhanced sound signal of A may be accurately collected. However, after the wearer lowers the head or turns the head, a direction of the sound signal that is of A and that is obtained by the directional microphone in the smart glasses changes. In this case, if the sound signal in front of the smart glasses is still enhanced, the obtained sound signal is no longer the sound signal of A. Therefore, to avoid the foregoing case, the posture and movement measurement unit in the wearable device may be used to obtain a variation of information relative to an initialized position of the wearer, and monitor a posture change of the wearer, to adaptively adjust a direction of the picked-up sound signal with head/wrist movement of the user. This implements real-time tracking of the sound signal.

It should be noted that, for future technology-oriented support, the smart glasses may be out of control of the main control device, and implement, by using a plurality of functional modules of the smart glasses, remote calling, hearing aid enhancement, and another function that originally needs to be implemented through control of the main control device. This is not limited in this application.

The following uses examples in which quantities of directional microphones in a microphone array are 1, 2, 3, 4, 6, and 9, to describe sound signal beams formed by different quantities of directional microphones in a wearable device. It should be noted that the following diagrams show only cases in which some directional microphones form sound signal beams in smart glasses. Based on different actual requirements, the quantity of directional microphones disposed in the smart glasses, a specific type of the directional microphone, and a specific installation position of the directional microphone may change. This is not limited in this application.

It should be noted that sound signal beams that can be obtained by a figure-8 microphone are shown by two adjacent dashed circles in FIG. 7 to FIG. 18, and a sound signal beam that can be obtained by an omnidirectional microphone is shown by one solid circle in FIG. 7 to FIG. 18.

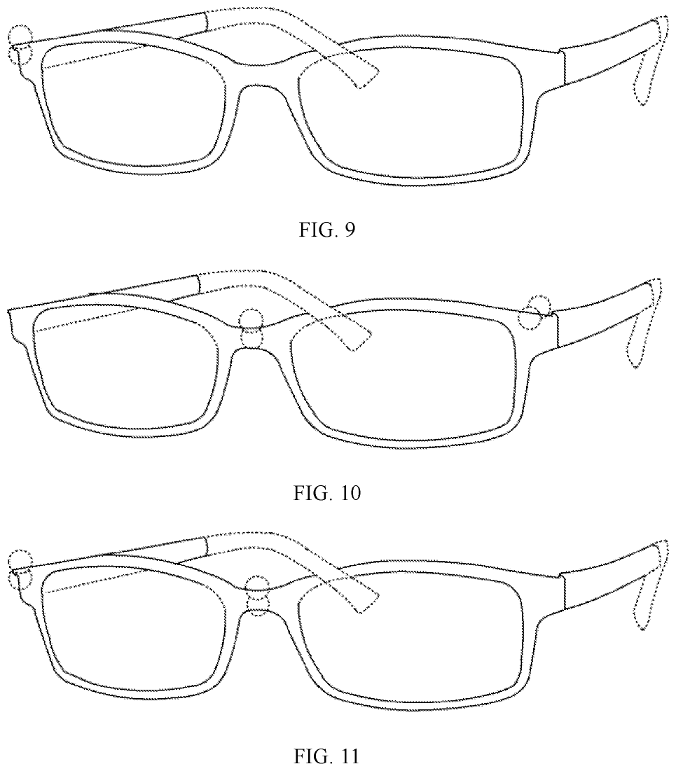

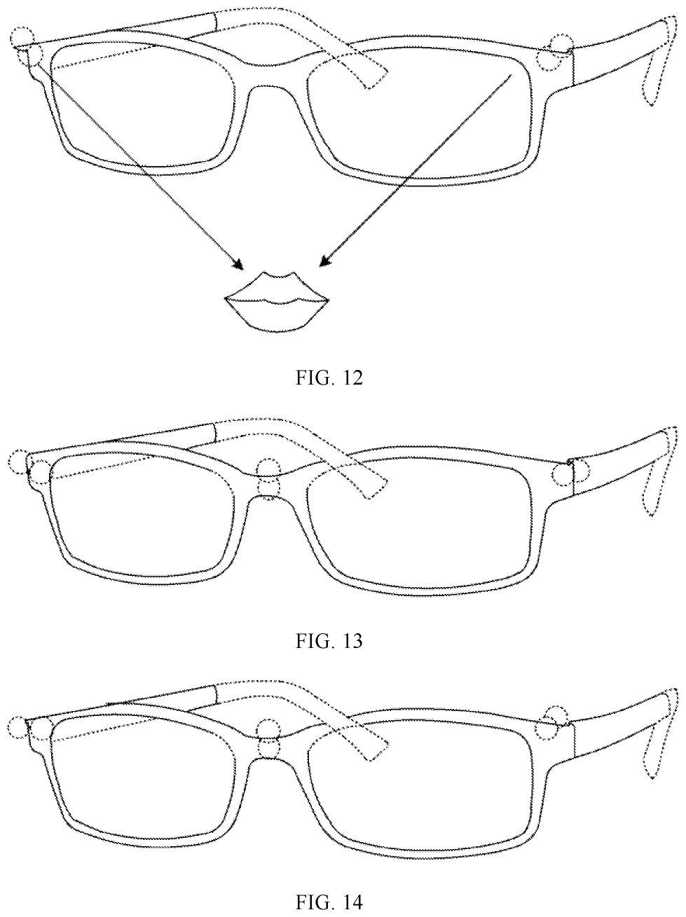

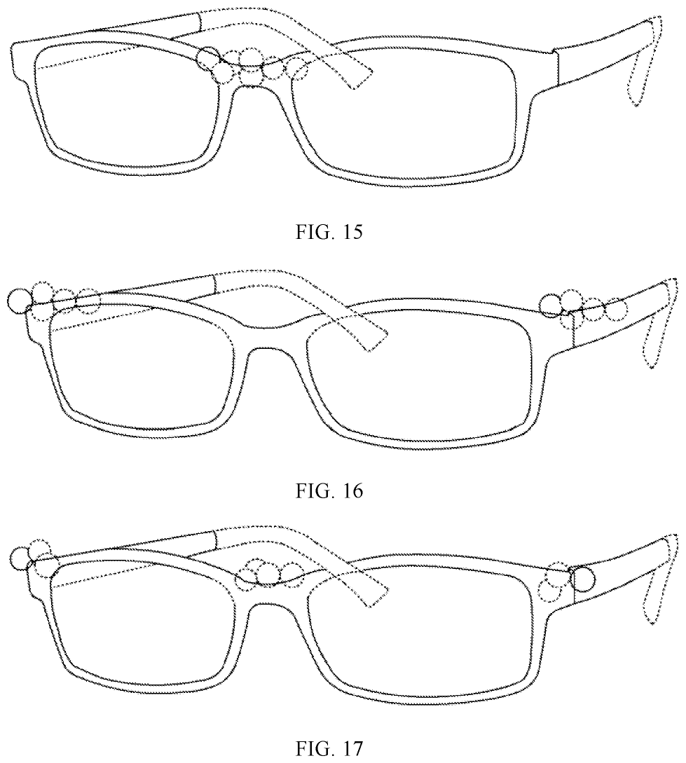

To further reduce a weight of the smart glasses and reduce pressure of the smart glasses on a nose bridge or ears of a wearer, in a possible implementation, one figure-8 microphone may be disposed in the smart glasses. Refer to FIG. 7 to FIG. 9. Refer to FIG. 7. The microphone may be disposed in a rim or a temple on one side of the smart glasses, and the microphone can form a sound signal beam that points to the mouth of the wearer, so that the microphone receives a sound signal from the mouth of the wearer. Refer to FIG. 8. The microphone may alternatively be disposed in a middle position between rims of the smart glasses, and a middle area means a bridge and/or nose pads of the rims of the smart glasses. The microphone may form a sound signal beam that points to the mouth of the wearer. Similarly, refer to FIG. 9. The microphone may alternatively be disposed in a rim or a temple on the other side of the smart glasses, and corresponds to a disposition position of the microphone in FIG. 7. A direction of a formed sound signal beam also correspondingly points to the mouth.

FIG. 10 to FIG. 12 are diagrams in which a second microphone array structure in the smart glasses forms beams according to an embodiment of this application. As shown in FIG. 10 to FIG. 12, the microphone array in the smart glasses includes two directional microphones, and types of the two directional microphones are both figure-8 microphones. Refer to FIG. 10. In an embodiment, one of the two figure-8 microphones is located in the middle position between the rims of the smart glasses, and a direction of a formed sound signal beam points to the mouth of the wearer; and the other microphone is located on a rim, a frame, or a temple on one side of the smart glasses, and the microphone forms a sound signal beam that points to the mouth of the wearer. Refer to FIG. 11. In another possible implementation, one of the two figure-8 microphones is located in the middle position between the rims of the smart glasses, and forms a sound signal beam that points to the mouth of the wearer; and the other microphone is disposed on a rim, a frame, or a temple on the other side of the smart glasses in correspondence to a disposition direction of one microphone shown in FIG. 10, and also forms a sound signal beam that points to the mouth of the wearer. Refer to FIG. 12. In another embodiment, the two figure-8 microphones are respectively correspondingly disposed on the rims, the rims, or the temples on the two sides of the smart glasses, and the two microphones each may form, in the smart glasses, a sound signal beam that points to the mouth of the wearer.

FIG. 13 is a diagram in which a third microphone array structure in the smart glasses forms beams according to an embodiment of this application. As shown in FIG. 13, three figure-8 microphones are disposed in the microphone array in the smart glasses. One microphone is disposed in the middle position between the rims of the smart glasses, and a direction of a formed sound signal beam points to the mouth of the wearer. Other two microphones are respectively disposed on the rims, the frames, or the temples on the two sides of the smart glasses, and directions of formed sound signal beams point to the mouth of the wearer.

Optionally, when there are three directional microphones, and the three directional microphones are of a same type, sound signal beams formed by the three directional microphones may be in a plurality of forms. For example, a position of the microphone disposed in the middle position remains unchanged, and positions of the other two microphones disposed on the rims or frame of the smart glasses may be changed. FIG. 14 is another diagram in which three figure-8 microphones disposed in a microphone array in smart glasses form beams. It is not difficult to learn from comparison between FIG. 13 and FIG. 14 that, after the disposition positions of the two microphones are changed, directions of the sound signal beams formed by the three microphones in FIG. 14 are symmetrical to the directions of the sound signal beams formed by the three microphones in FIG. 13, and impact on actually collecting a sound signal of the wearer is relatively small.

FIG. 15 is a diagram in which a fourth microphone array structure in the smart glasses forms beams according to an embodiment of this application. As shown in FIG. 15, the microphone array in the smart glasses may include four directional microphones. One directional microphone is an omnidirectional microphone, and three directional microphones are all figure-8 microphones. The four microphones are all located in the middle position between the rims of the smart glasses, and the middle area includes the bridge and/or the nose pads of the rims of the smart glasses. Directions of sound pickup beams formed by the three figure-8 microphones are orthogonal to each other. For example, the sound pickup directions formed by the three figure-8 microphones are perpendicular to the rim of the smart glasses, are parallel to the rim of the smart glasses, and point to the mouth of the wearer respectively.

FIG. 16 is a diagram in which another microphone array structure in the smart glasses forms beams according to an embodiment of this application. As shown in FIG. 16, the microphone array in the smart glasses may include six directional microphones. Two directional microphones are omnidirectional microphones, and the omnidirectional microphones may be disposed on rims, frames, or temples on hinges of the smart glasses. Other four directional microphones are figure-8 microphones. Two figure-8 microphones are located in the middle position between the rims of the smart glasses and respectively form sound pickup directions that are perpendicular to and parallel to a lens of the smart glasses. Other two figure-8 microphones are located on the rims, frames, or temples on the hinges of the smart glasses, and form sound pickup directions that point to the mouth of the wearer wearing the smart glasses.

FIG. 17 is a diagram in which a microphone array structure in the smart glasses forms beams according to an embodiment of this application. As shown in FIG. 17, the microphone array in the smart glasses also includes six directional microphones. Two directional microphones are omnidirectional microphones, and four directional microphones are figure-8 microphones. The two omnidirectional microphones are respectively located on the rims, frames, or temples on the hinges on the two sides of the smart glasses. Two of the four figure-8 microphones are located on a rim, frame, or temple on one hinge of the smart glasses, and are adjacent to one omnidirectional microphone. Sound pickup directions formed by the two figure-8 microphones point to the mouth of the wearer and are parallel to the rim of the smart glasses respectively. Other two figure-8 microphones are located on a rim, frame, or temple on the other hinge of the smart glasses, and are adjacent to the other omnidirectional microphone. Sound pickup directions formed by the other two figure-8 microphones point to the mouth of the wearer and are parallel to the rim of the smart glasses respectively.

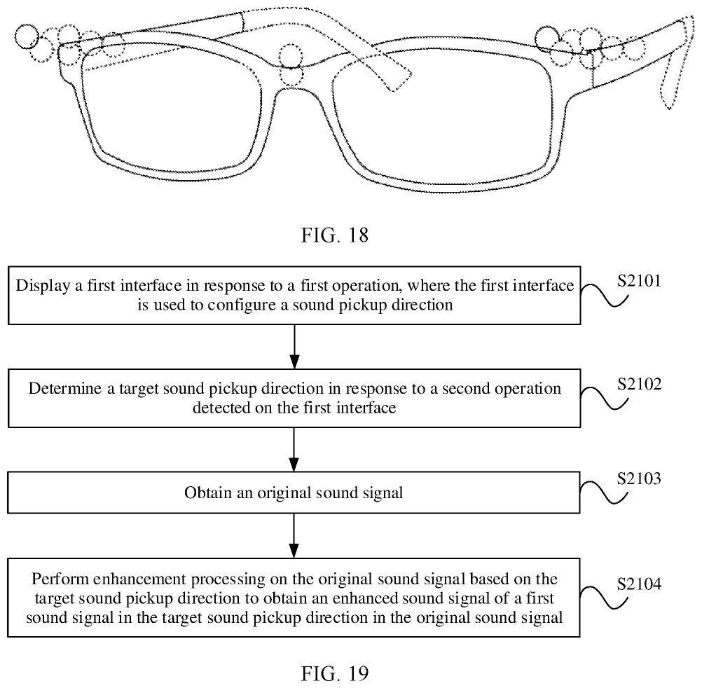

FIG. 18 is a diagram in which a microphone array structure in the smart glasses forms sound signal beams according to an embodiment of this application. As shown in FIG. 18, the microphone array in the smart glasses may include nine directional microphones. Two directional microphones are omnidirectional microphones, and seven directional microphones are figure-8 microphones. The two omnidirectional microphones are respectively disposed on the rims, the frames, or the temples on the two sides of the smart glasses. One of the seven figure-8 microphones is disposed in the middle position between the rims of the smart glasses, and a sound signal beam formed by the microphone points to the mouth of the wearer. Three figure-8 microphones are disposed on a rim or a temple on each side of the smart glasses, and sound signal beams formed by the three figure-8 microphones disposed on each side are orthogonal to each other.

It should be noted that, if there are two or more directional microphones in the microphone array, when a plurality of directional microphones are actually deployed in the smart glasses, installation positions of a plurality of microphones of a same type are not limited. When there is one directional microphone in the microphone array, the microphone may be installed in a plurality of positions in the smart glasses.

It should be understood that, when the microphone array includes one omnidirectional microphone, the omnidirectional microphone is located in a bridge or a nose pad of a rim of the smart glasses. When the microphone array includes two omnidirectional microphones, the two omnidirectional microphones may be respectively located on two temples of the smart glasses, or the two omnidirectional microphones are respectively located in positions that are on two sides of rims of the smart glasses and that are close to two temples. When the microphone array includes a plurality of omnidirectional microphones, the plurality of omnidirectional microphones are distributed in a middle area and two side areas of the smart glasses, the middle area includes a bridge and/or nose pads of rims of the smart glasses, and the two side areas include two temples of the smart glasses and/or positions that are on two sides of the rims of the smart glasses and that are close to the two temples. For example, when the microphone array includes three omnidirectional microphones, two of the three omnidirectional microphones may be respectively located in the rims on the two sides of the smart glasses that are close to the temples, or are located in the temples on the two sides of the smart glasses that are close to the rims, and one omnidirectional microphone is located in the bridge or the nose pad of the rim of the smart glasses.

Positions of omnidirectional microphones are set based on a quantity of omnidirectional microphones, so that the omnidirectional microphones in the microphone array can evenly pick up the sound from as many directions as possible, to obtain diverse and wide-range audio signals or noise. Based on different actual application requirements, noise reduction and enhancement processing may be performed, by using the audio signals or noise obtained by the omnidirectional microphone, on the audio signal collected by the directional microphone. This improves sound pickup quality of the directional microphone, and further enhances sound pickup performance of the smart glasses.

In an actual application process, to reduce power consumption of the smart glasses, improve user experience, and prolong a service life of the smart glasses, when a wearable device detects a target sound pickup direction, the wearable device enables a microphone that is in a microphone array and that points to the target sound pickup direction, and disable a microphone that is in the microphone array and that does not point to the target sound pickup direction.

To prevent, as much as possible, the microphone from picking up noise in a direction other than the target sound pickup direction, and enhance sound pickup effect, alternatively, when detecting that a first directional microphone that meets a preset condition exists in the microphone array, the smart glasses enable the first directional microphone, and disable another directional microphone in the microphone array. The preset condition is that signal quality of a sound signal picked up by the first directional microphone is higher than signal quality of a sound signal picked up by the another directional microphone in a preset time period. The preset condition may be set based on different actual application requirements. This is not limited in this application.

It should be understood that a signal quality parameter of the sound signal includes but is not limited to loudness of the sound signal and a signal-to-noise ratio of the sound signal.

It should be further noted that, with continuous development of technologies, there are more types of microphones. For different application scenarios, types of used directional microphones may be different. Specific types of the directional microphones in different application scenarios are not limited in this application.

In addition, based on the different actual application requirements, the directional microphone may alternatively be disposed in another sound pickup device, for example, a device having a sound pickup function, like a headset or a smart helmet. This is not limited in this application.

An embodiment of this application further provides a sound pickup method, to enhance an original sound signal in a specific direction by flexibly adjusting a sound pickup direction. This improves intelligibility, sound quality, and clarity of the sound signal in the specific direction. The following describes an example of the sound pickup method provided in this embodiment of this application with reference to several possible scenarios.

Scenario 1: The sound pickup method may be used by an electronic device in a scenario in which the electronic device autonomously picks up a sound. The electronic device may also be referred to as a terminal device, a mobile device, or a terminal. The electronic device is a device that has a sound pickup function and an interface display function, and includes but is not limited to a handheld device, a vehicle-mounted device, a computing device, or another device installed with a directional microphone. For example, the electronic device may include a mobile phone, a personal digital assistant, a tablet computer, a vehicle-mounted computer, a laptop computer, a smart screen, an ultra-mobile personal computer (UMPC), a wearable device, and another electronic device that has the sound pickup function and the display function.

FIG. 19 is a schematic flowchart of a sound pickup method according to an embodiment of this application. Refer to FIG. 19. The sound pickup method includes the following steps.

S2101: Display a first interface in response to a first operation, where the first interface is used to configure a sound pickup direction.

In this embodiment of this application, the first operation may be a tap operation, a touch operation, or a slide operation that is entered by a user on a display of an electronic device, or a control operation that is entered by the user by using a physical button on the electronic device, or a mid-air gesture detected by the user by using a camera or another sensor of the electronic device, or the like.

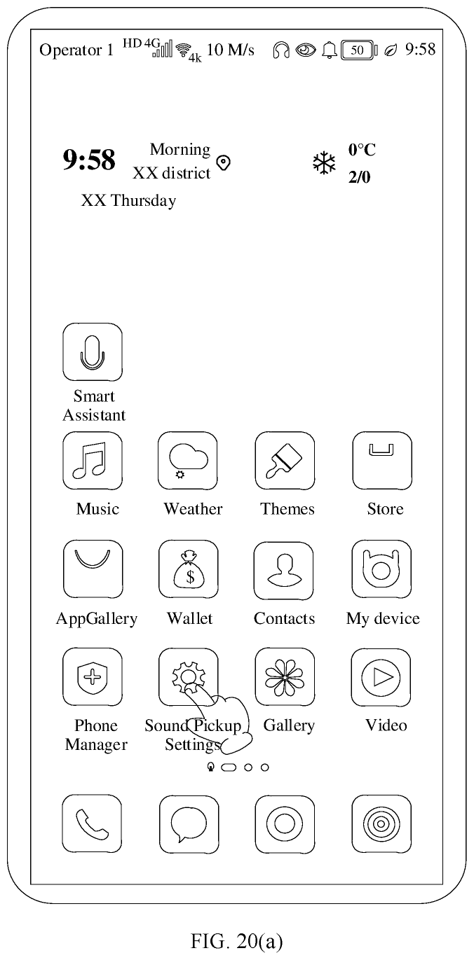

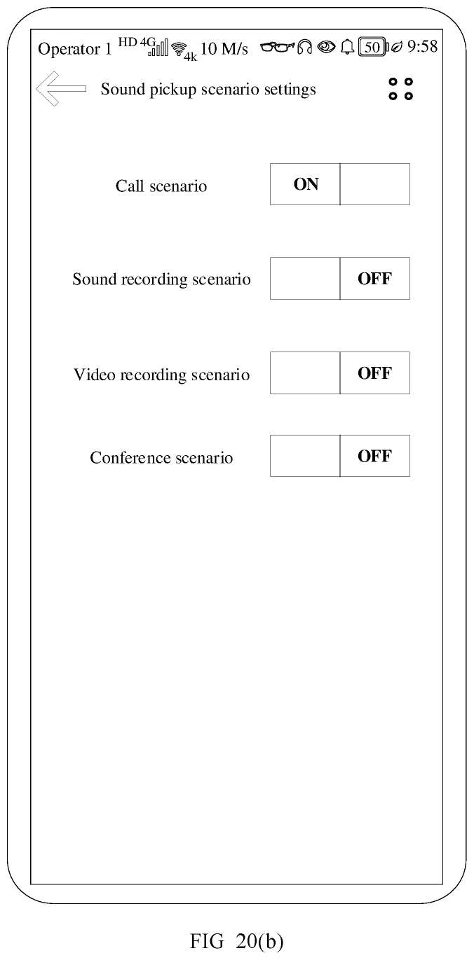

For example, a “sound pickup settings” key is displayed on a settings page or a desktop of the electronic device. For example, as shown in FIG. 20(a), a “sound pickup settings” key is displayed on the desktop of the electronic device. After the user taps the key, a screen display system of the electronic device directly displays the first interface, allowing the user to set a default sound pickup direction.

Alternatively, after the user taps the key, the electronic device may also display a sound pickup scenario setting interface, allowing the user to set a scenario in which the first interface may be directly enabled for sound pickup settings, for example, whether to enable the sound pickup settings in a scenario in which an incoming call is answered, a scenario in which sound recording is enabled, or a hands-free (which may also be referred to as sound amplification or speaker) scenario. After the settings are completed and the electronic device detects that a corresponding scenario is triggered, the screen display system of the electronic device automatically displays the first interface. Triggering of the corresponding scenario is the first operation responded by the electronic device.

It should be understood that, as shown in FIG. 20(b), the sound pickup settings scenario that may be set includes but is not limited to a sound recording scenario, a call scenario, a video recording scenario, and a conference scenario. The call scenario may be a voice call scenario, or may be a video call scenario, or certainly, may be a conference call scenario.

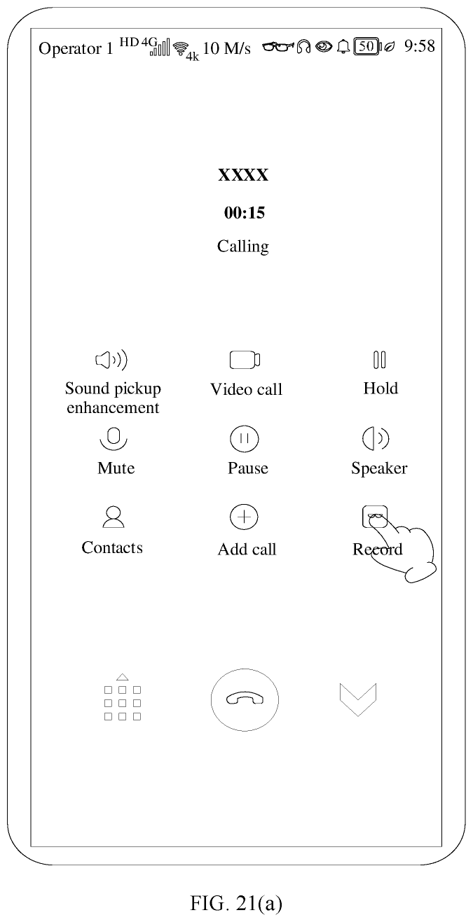

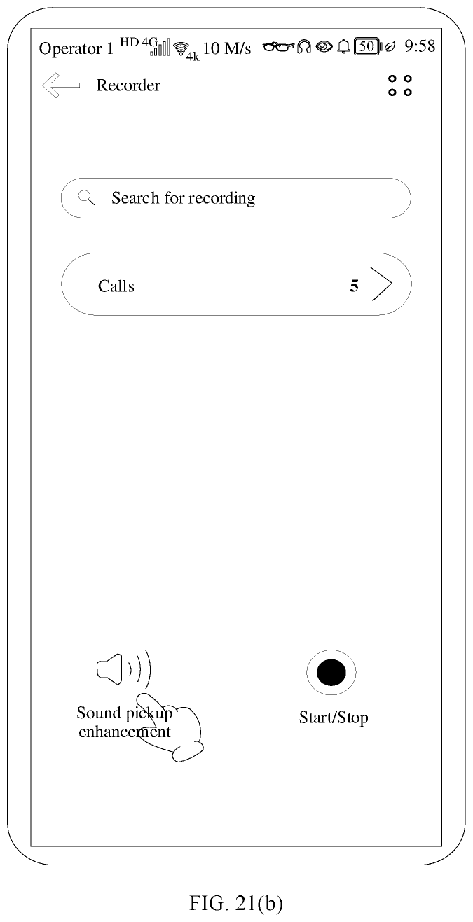

For example, in the sound recording scenario, when detecting that the user taps a sound recording key to enable sound recording, the electronic device may directly jump to the first interface. For example, as shown in FIG. 21(a), after the user taps a sound recording function key on a call screen, the screen display system of the electronic device displays the first interface; or when the user taps a sound recording function key displayed on the electronic device, the screen display system of the electronic device displays the first interface.

Alternatively, as shown in FIG. 21(b), after the user taps a sound recording function key corresponding to a sound recording application displayed on the desktop of the electronic device, a sound recording interface is displayed. A sound pickup enhancement key is displayed on the sound recording interface. When the user needs to enhance local sound recording in a specified direction, the user may tap the sound pickup enhancement key, so that after the electronic device detects that the user taps the sound pickup enhancement key, the screen display system of the electronic device jumps to the first interface, and then enables a sound recording function based on a sound recording start operation. This performs enhancement processing on a sound signal in local sound recording.

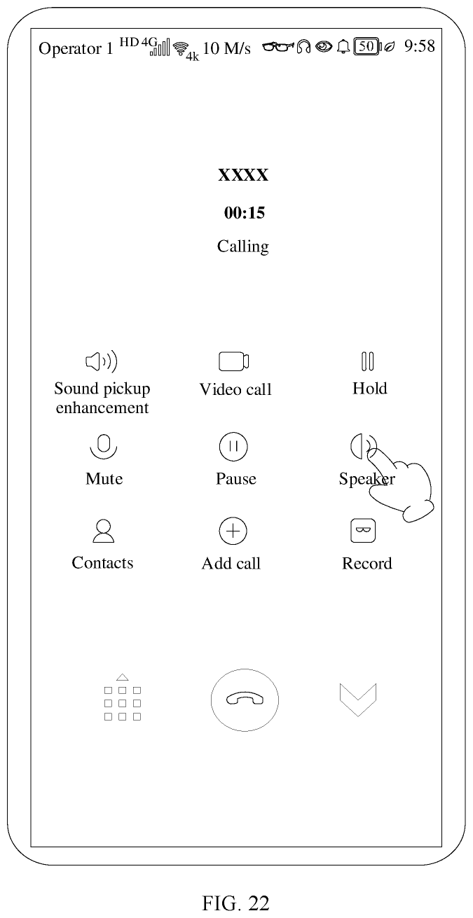

For another example, on the call screen shown in FIG. 22, after the electronic device detects that the user taps a key like a loudspeaker (also referred to as sound amplification or hands-free) key, the screen display system of the electronic device displays the first interface.

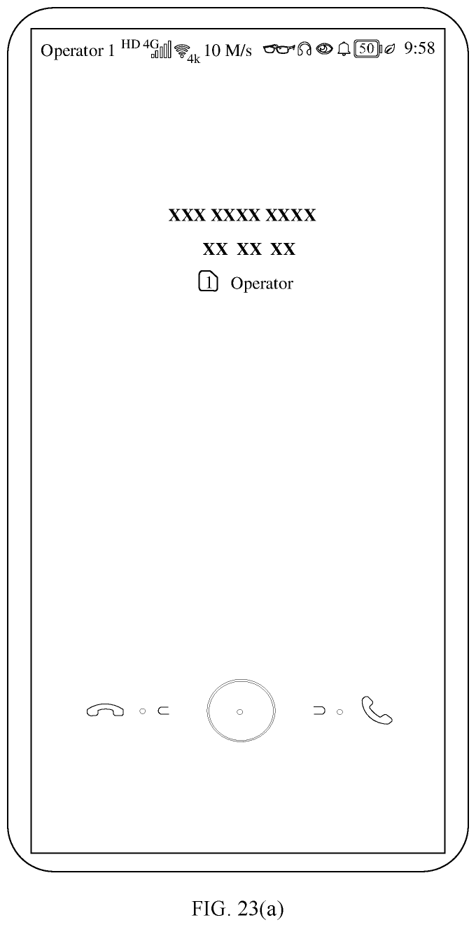

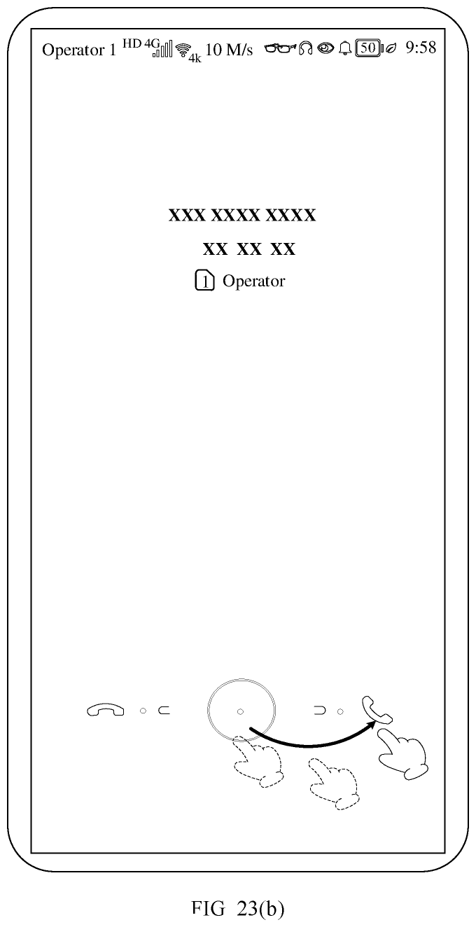

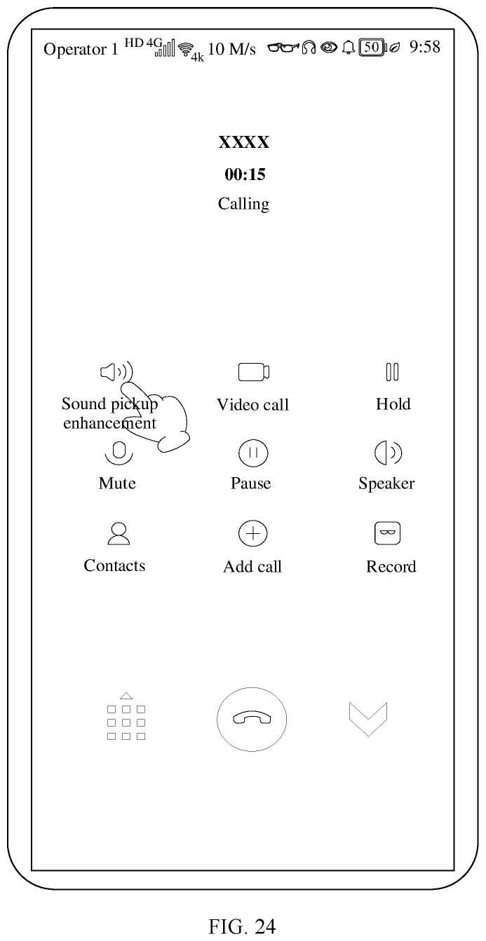

For another example, refer to FIG. 23(a) and FIG. 23(b). After an incoming call (also referred to as a call), the electronic device displays a screen shown in FIG. 23(a). The user may perform, on the screen display system of the electronic device, a slide operation shown in FIG. 23(b) to answer the incoming call. After the incoming call is answered, the screen display system of the electronic device directly displays the first interface.

For another example, in a scenario in which an incoming call is answered shown in FIG. 24, after the user taps a “sound pickup enhancement” function key shown in FIG. 24, the screen display system of the electronic device displays the first interface.

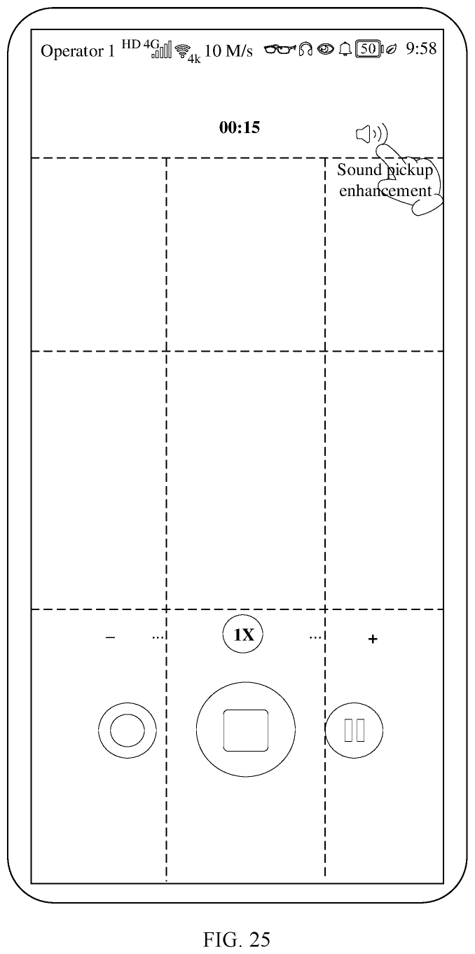

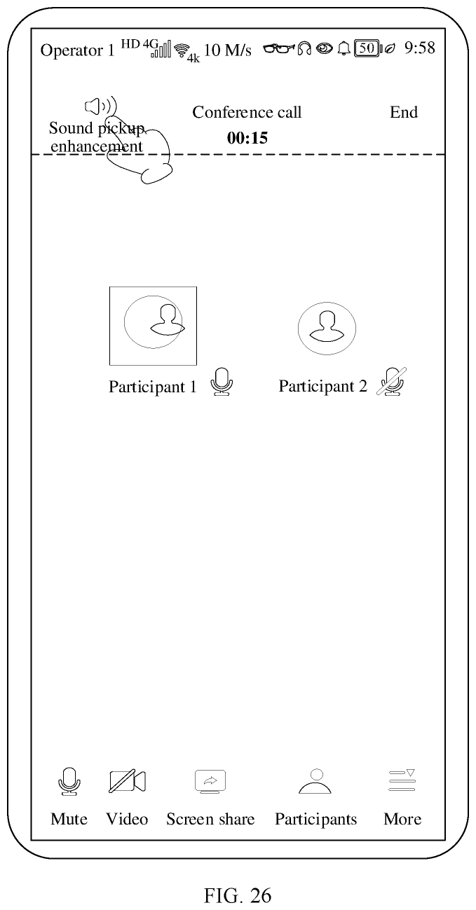

In a possible implementation, on a video recording interface shown in FIG. 25, after the user taps the “sound pickup enhancement” function key, the screen display system of the electronic device directly displays the first interface; or after the user directly taps a video recording function key corresponding to a video recording application displayed on the desktop of the electronic device, the screen display system of the electronic device displays the first interface.

In another possible implementation, a “sound pickup enhancement” configuration key is displayed in a conference interface shown in FIG. 26. After the user taps the configuration key, the screen display system of the electronic device displays the first interface; or after the user directly taps a conference function key, to enable a conference function, the screen display system of the electronic device directly displays the first interface.

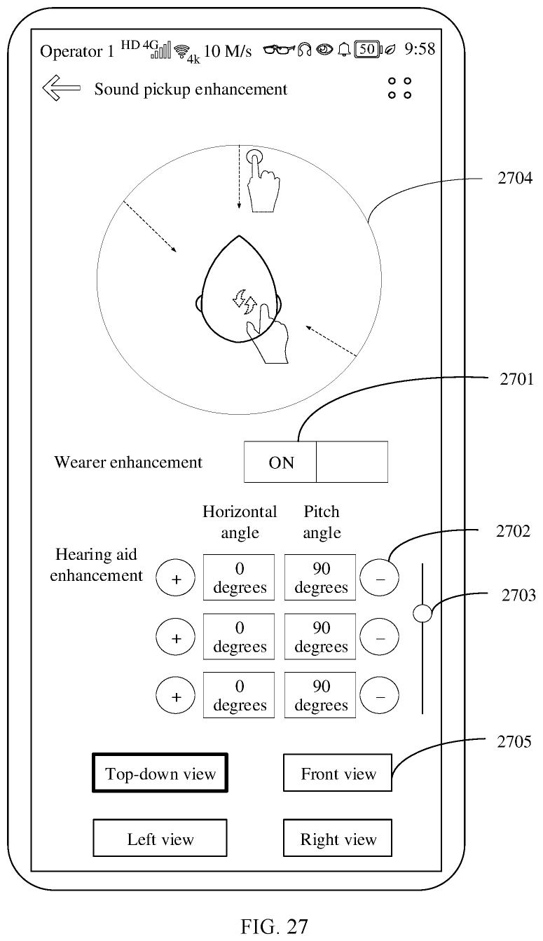

FIG. 27 is a diagram of a first interface according to an embodiment of this application. The first interface may include a first on/off key 2701 used to enhance a sound signal of a wearer, a manual add key 2702 (and/or a positioning key 2703 on a slide bar) for hearing aid enhancement, a sound signal direction display diagram 2704, and a tap key 2705 that can be used to switch between different views.

The first on/off key 2701 is used to enable or disable enhancement of the sound signal of the wearer. The manual add key 2702 (or the positioning key 2703 on the slide bar) for hearing aid enhancement is used to determine to increase or decrease a to-be-enhanced sound signal and corresponding direction information of the sound signal. The sound signal direction display diagram 2704 is used to display a simulated sound pickup environment, including a head of the wearer and a sound pickup environment centered around the head of the wearer. The tap key 2705 of the different views may be used to switch between the different views of the wearer in the sound signal direction display diagram 2704.

It should be understood that, based on different actual application scenarios, display content in the foregoing example may be added to the first interface, or some display content in the foregoing example may be reduced. The content displayed on the first interface is not limited in this application.

It is not difficult to understand that, when the electronic device is a device having a display, like a smartphone, a smartwatch, or a tablet computer, the electronic device may display, on the display of the electronic device in response to the first operation, the first interface used to configure a sound pickup direction. When the electronic device is a device that displays an image through projection, or the like, for example, an augmented reality device or a virtual reality device, the electronic device may display the first interface in response to the mid-air gesture.

S2102: Determine a target sound pickup direction in response to a second operation detected on the first interface.

The target sound pickup direction is used to enhance an original sound signal in a specified direction. With reference to the first interface shown in FIG. 27, the following describes how to determine the target sound pickup direction.

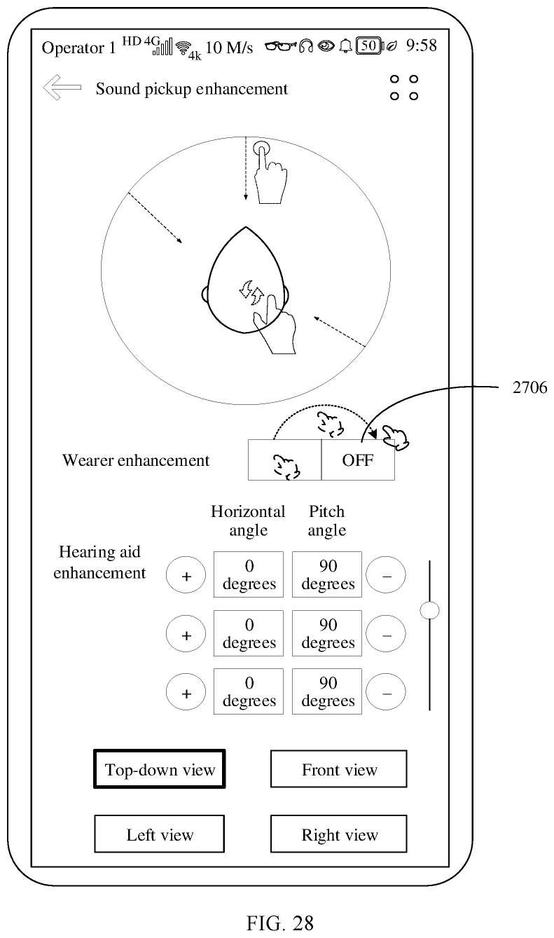

When the target sound pickup direction is a sound direction of the wearer, the electronic device may enable or disable, based on the first interface in response to a tap or slide operation of the user on the first on/off key 2701, enhancement of the sound signal of the wearer. A state shown by the first on/off key 2701 in FIG. 27 indicates that enhancement of the sound signal of the wearer is enabled, and a state shown by a second on/off key 2706 in FIG. 28 indicates that enhancement of the sound signal of the wearer is disabled. The first on/off key 2701 and the second on/off key 2706 may be a same on/off key.

When the target sound pickup direction is not the sound direction of the wearer, the user may add the target sound pickup direction through the manual add key 2702 or the positioning key 2703 on the slide bar shown in FIG. 27. The user may further switch, based on the sound signal direction display diagram 2704, an angle of the wearer through a first gesture, and then increase or decrease a direction of the to-be-enhanced sound signal through a second gesture. Alternatively, the user can switch between the different views of the wearer in the sound signal direction display diagram 2704 through the tap key 2705, and then increase or decrease, based on the sound signal direction display diagram 2704, a direction of the to-be-enhanced sound signal through a second gesture.

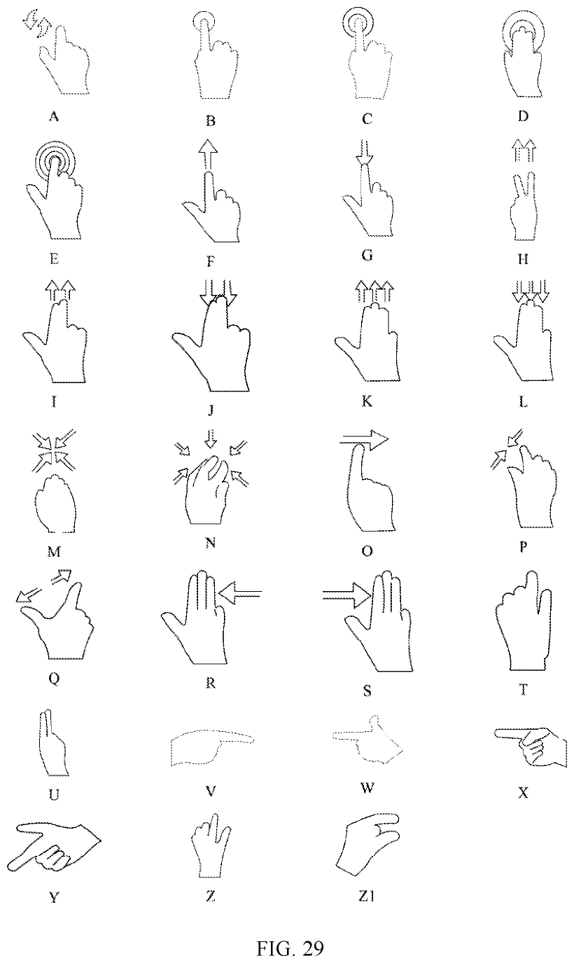

For example, the first gesture may be a rotation gesture shown by Ain FIG. 29, and the second gesture may be a touch and hold gesture shown by E in FIG. 29. It should be understood that, based on different use settings, the first gesture and the second gesture may be the same or different. When it is ensured that the first gesture and the second gesture are different, the first gesture and/or the second gesture may be any possible gesture shown in A to Z1 in FIG. 29. Examples are not provided one by one herein again.

It should be noted that, in addition to determining the target sound pickup direction in the manners in the foregoing examples, the target sound pickup direction may be further determined through the mid-air gesture or another control command. This is not limited in this application.

It should be noted that there may be one or more target sound pickup directions. For example, the target sound pickup direction may include the sound direction of the wearer, and another direction that is set through hearing aid enhancement.

S2103: Obtain an original sound signal.

The electronic device obtains the original sound signal in an environment by using a built-in microphone array. The microphone array may include at least one directional microphone, or may include at least one directional microphone and at least one omnidirectional microphone. In different application scenarios, the microphone array may alternatively include at least one omnidirectional microphone.

It should be understood that, in actual application, the electronic device may enable, based on the target sound pickup direction, a directional microphone that points to the target sound pickup direction, disable a directional microphone that does not point to the target sound pickup direction, and collect the original sound signal by using the enabled directional microphone that points to the target sound pickup direction. In this way, power consumption of the electronic device can be reduced, user experience is improved, and a service life of smart glasses is prolonged. In addition, the electronic device enables, based on the target sound pickup direction, the microphone that points to the target sound pickup direction, and disables another microphone. This can further prevent, as much as possible, the microphone from picking up noise in a direction other than the target sound pickup direction, and enhance sound pickup effect of the microphone. In actual application, different types of the sound pickup effect can be further implemented by using an enabled state or a disabled state of each directional microphone, to enhance use performance of the electronic device.

S2104: Perform enhancement processing on the original sound signal based on the target sound pickup direction to obtain an enhanced sound signal of a first sound signal in the target sound pickup direction in the original sound signal.

It should be understood that the enhanced sound signal obtained through enhancement processing may be used for play or storage, or may be forwarded to another device, or the like. As an example rather than a limitation, for a sound pickup scenario, the enhanced sound signal obtained through enhancement processing may be used for play, to better help a person wearing a hearing aid device hear the sound signal; for a sound recording scenario, the enhanced sound signal obtained through enhancement processing may be used for storage, so that the user can hear repeatedly later; for a call scenario, the enhanced sound signal obtained through enhancement processing may be sent to a calling end device; for a video recording scenario, the enhanced sound signal obtained through enhancement processing may be used to replace an original sound signal in a recorded original video, so that the user can hear the enhanced sound signal when viewing the recorded video later, improving user experience; and for a conference scenario, the enhanced sound signal obtained through enhancement processing may be sent to a conference device, to facilitate better communication and interaction. Based on different actual application scenarios, the enhanced sound signal obtained through enhancement processing is used for different purposes. This is not limited in this application.

In this embodiment of this application, enhancement processing performed on the first sound signal in the target sound pickup direction in the original sound signal includes sound intensity improvement and/or noise reduction processing on the sound signal, to improve intelligibility, sound quality, and clarity of the sound signal in the specific direction.

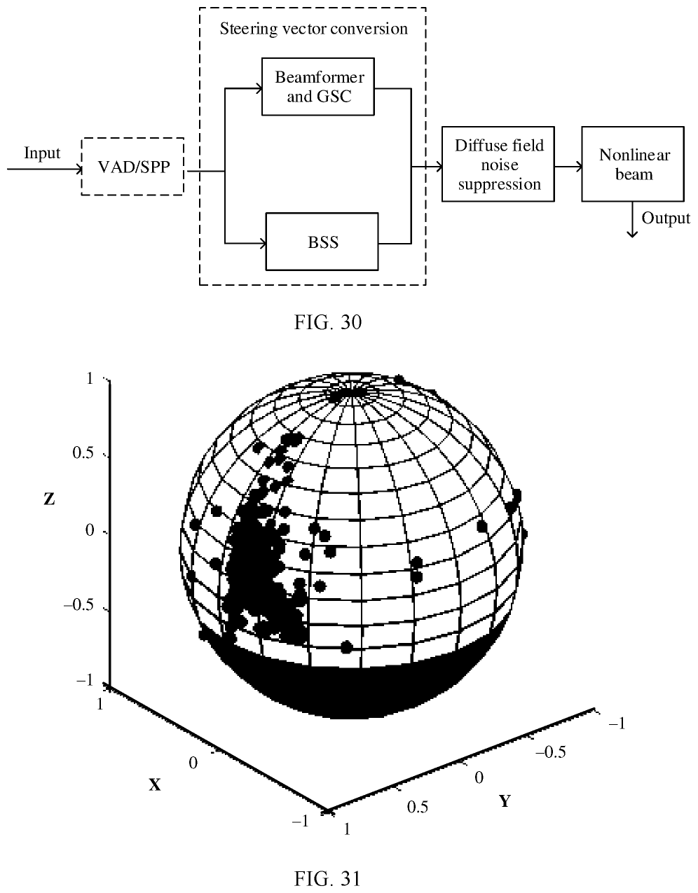

FIG. 30 is a schematic flowchart of a noise reduction and extraction process of a sound signal according to an embodiment of this application. The noise reduction and extraction process of the sound signal means that noise reduction and extraction are performed on the original sound signal based on the target sound pickup direction, to obtain the sound signal from which relatively much noise is screened out. Refer to FIG. 30. The noise reduction process includes: Step 1: Obtain the original sound signal based on the microphone array.

Step 2: Correspondingly convert the obtained sound signal into a steering vector sound signal based on the target direction. A method for converting the obtained sound signal into the steering vector sound signal includes but is not limited to: processing the obtained sound signal by using a beamformer and a generalized sidelobe canceller (GSC), to obtain the steering vector sound signal oriented toward the target direction; or processing the obtained sound signal by using a blind source separation (BSS) technology based on the target direction, to obtain the steering vector sound signal corresponding to the target direction.

It should be understood that, this step is essentially to preprocess sound signals collected by the directional microphone, to separate different sound signals from a plurality of sources. This eliminates noise in a direction other than the target direction, suppresses noise, and extracts a target sound signal.

Step 3: Suppress diffuse field noise. A diffuse field means a sound field in which energy density of sound signals is evenly distributed, and the sound signals are randomly distributed in all propagation directions. The diffuse field noise is sound signals from all directions in entire space of the sound field, for example, a sound signal generated by an air conditioner for cooling or heating.

In this embodiment of this application, diffuse field noise suppression may be performed on the steering vector sound signal (or the sound signal collected by the directional microphone) based on an energy relationship between sound signals from different channels.

The following uses a directional microphone array (AVS) as an example. It may be determined whether a sound signal is a direct sound or diffuse field noise based on an energy relationship between sound signals arriving at a same AVS from the channels. Specifically, when sound field space is an ideal diffuse field, sound signals collected by an omnidirectional channel and channels of three axes, namely, x, y, and z meet the following formula (1):

$${X}_{w}^{2} = {X}_{x}^{2} + {X}_{y}^{2} + {X}_{z}^{2} \qquad ( 1 )$$

The ideal diffuse field means a sound field in which sound signals from all directions of the sound field space have same energy, but are not correlated with each other. In the foregoing formula (1), X_{w}, indicates sound signals collected by the omnidirectional channel, and Xₓ, X_{y}, and X_{z} respectively indicate sound signals collected by the channels of the three axes, namely, x, y, and z.

It can be learned from the foregoing formula (1) that, when there is only a point sound source located in one of the three-axis channels in the sound field space, for example, in an x-axis channel, sound signals collected by the omnidirectional channel and a sound signal collected by the x-axis channel meet the following formula (2):

$${X}_{w} = {X}_{x} \qquad ( 2 )$$

It should be understood that, when there is only a point sound source located in either of the y-axis channel and the z-axis channel in the three-axis channels or any direction in other three-dimensional space in the sound field space, a condition similar to the foregoing formula (2) is met. In this case, it may be determined, based on an energy relationship between sound signals collected by the channels, whether a sound signal collected by the AVS at each time-frequency bin (a point determined by both time and a frequency) is a point sound source or diffuse field noise, that is, the following formula (3) is met:

$$1 \leq \frac{{X}_{w}^{2}}{{X}_{x}^{2} + {X}_{y}^{2} + {X}_{z}^{2}} \leq 3 \qquad ( 3 )$$

For example, the electronic device is the smart glasses shown in FIG. 15. The microphone array in the smart glasses includes four coincident directional microphones. One of the four directional microphones is an omnidirectional microphone, three directional microphones are figure-8 microphones, and sound signal beams formed by the three figure-8 microphones are orthogonal to each other. If strength of a single sound signal received by the three figure-8 microphones is equal to strength of a sound signal received by the omnidirectional microphone, the strength X_{w1} of the sound signal received by the omnidirectional microphone and the strength Xₓ₁ of the sound signal received by the figure-8 microphone meet the following formula (4):

$${X}_{w 1}^{2} = 3 {X}_{x 1}^{2} \qquad ( 4 )$$

It is determined, by using the foregoing formula (4), whether the sound signal is a point sound source.

In an actual process of suppressing the diffuse field noise, mapping conversion may be further performed on the foregoing formula (3), to perform filtering suppression on the diffuse field noise. A mapping conversion method includes but is not limited to Gaussian distribution or even distribution.

Step 4: Perform nonlinear beam processing, to implement directional collection of a sound signal, and suppress interference of a sound signal in a direction other than the target direction.

Nonlinear beam processing may be performed by using a method like position estimation or spatial clustering estimation of the sound signal. The position estimation method is essentially to estimate a direction of the sound signal by calculating a direction of arrival of each time-frequency bin by using a sound intensity vector collected by the AVS, to screen out a sound signal that is not in the target direction.

Specifically, in the position estimation method, a sound intensity vector collected by each AVS may be indicated by the following formula (5). In the following formula (5), (f,n) indicates a time-frequency bin whose frequency bin is f and a frame quantity is n, X_{w} indicates the sound signals collected by the omnidirectional channel, and Xₓ, X_{y}, and X_{z} respectively indicate the sound signals collected by the channels of the three axes, namely, x, y, and z.

$$[ \begin{matrix}{I}_{x} \\ {I}_{y} \\ {I}_{z}\end{matrix} ] = \{ \begin{matrix}{X}_{w}^{*} ( f , n ) * {X}_{x} ( f , n ) \\ {X}_{w}^{*} ( f , n ) * {X}_{y} ( f , n ) \\ {X}_{w}^{*} ( f , n ) * {X}_{z} ( f , n )\end{matrix} \qquad ( 5 )$$

A position corresponding to the time-frequency bin is determined by using the following formula (6):

$$( θ , φ ) = ( a tan ( \frac{R ( {I}_{z} )}{R ( \sqrt{{I}_{x}^{2} + {I}_{y}^{2}} )} ) , a tan 2 ( \frac{R ( {I}_{y} )}{R ( {I}_{x} )} ) ) \qquad ( 6 )$$

In the foregoing formula (6), R(*) indicates taking real part. After the position of the time-frequency bin is calculated according to the foregoing formula (6), the position of the time-frequency bin is compared with the target direction, and then a comparison result is mapped to a corresponding coefficient of a filter by using a Gaussian function, to suppress the sound signal in the direction other than the target direction.

As an example rather than a limitation, assuming that a difference between the position of the time-frequency bin and the target direction is 0° according to the foregoing formula (6), it may be considered that the position of the time-frequency bin is consistent with the target direction. In other words, a sound signal corresponding to the time-frequency bin is the target sound signal (or there is a relatively high probability that the sound signal corresponding to the time-frequency bin is the target sound signal). In this case, the corresponding mapped coefficient of the filter may be determined as 1, so that the sound signal corresponding to the time-frequency bin may be reserved in the filter for filtering. On the contrary, if it is determined, according to the foregoing formula (6), that the difference between the position of the time-frequency bin and the target direction is 180°, it may be considered that the position of the time-frequency bin is inconsistent with the target direction, or there is a relatively high probability that the sound signal corresponding to the time-frequency bin is noise. In this case, the mapped coefficient of the filter corresponding to the time-frequency bin may be determined as 0, to screen out the sound signal. In this example, a parameter like the comparison result between the position of the time-frequency bin and the target direction and the corresponding mapped coefficient of the filter may be set based on an actual application situation. This is not limited in this application.

In the spatial clustering estimation method, a sound pickup environment is simulated as one spherical surface (that is, a sound pickup environment simulation sphere shown in FIG. 31) by using position information of the sound signal, and a sound signal that is not in the target direction is screened out by performing spatial feature computation (or commutating a distance between the sound signal and the sphere, or the like) on the sound signal, to extract the sound signal in the target direction.

It should be understood that FIG. 31 is a diagram of performing spatial feature clustering on a sound signal according to an embodiment of this application. Refer to FIG. 31. The sound pickup environment is simulated by using the sound pickup environment simulation sphere. Points on the spherical surface of the sound pickup environment simulation sphere are several sound signals that are correspondingly mapped to the spherical surface. The several sound signals are correspondingly mapped to the spherical surface of the sound pickup environment simulation sphere, to suppress a sound signal that is not on a sector surface on the spherical surface. This can extract a sound signal in a specific direction. For example, based on the sound signal shown in FIG. 31, it may be learned that sound signals obtained through spatial feature clustering are concentrated in a direction in which X=0 and Y=1, and a sound signal that is not in the direction may be suppressed. In this case, the sound signals in the direction in which X=0 and Y=1 are extracted.

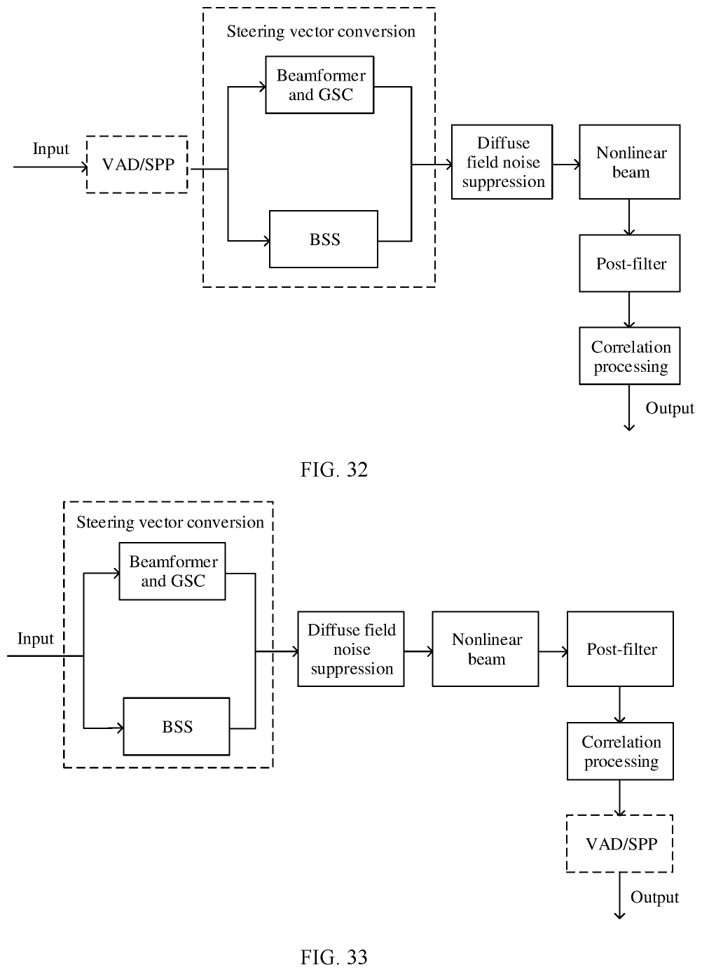

When the electronic device includes the at least one directional microphone, an output sound signal may be further processed based on a quantity of directional microphones in the electronic device. If the microphone array in the electronic device includes one directional microphone, steering vector conversion, diffuse field noise suppression, and nonlinear beam processing may be performed on the sound signal based on the noise reduction process shown in FIG. 30, to extract the target sound signal. To improve recognition accuracy of the sound signal and further enrich functions of the electronic device, two or more directional microphones may be disposed in the electronic device. In this case, refer to a noise reduction process shown in FIG. 32. Correlation processing may be performed on the sound signal obtained through steering vector conversion, diffuse field noise suppression, and nonlinear beam processing. Correlation processing is to compare similarities between a plurality of obtained sound signals, to determine a to-be-output sound signal from the plurality of sound signals.

To further screen out noise in the sound signal obtained through the steering vector conversion, the diffuse field noise suppression, and the nonlinear beam processing, and further reduce impact of the noise on the sound signal in the target direction, in a possible implementation, the sound signal is further processed by using a post-filter. In this case, sound signal steering vector conversion, diffuse field noise suppression, nonlinear beam, and post-filter processing are performed on the sound signal obtained by the directional microphone in the microphone array, to extract a relatively accurate target sound signal.

Through the foregoing several steps, the sound signal obtained by the directional microphone array may be processed, and the sound signal that suppresses diffuse field noise and the noise that is not in the target direction are extracted. Optionally, in a process of processing the sound signal obtained by the directional microphone array, a sound signal in a mute state may be further recognized and eliminated by using a method like voice activity detection (VAD) or speech presence probability (SPP) from the collected sound signal, to accelerate a sound pickup speed of the sound signal and improve a sound pickup rate.

It should be noted that, to avoid impact of noise filtering processing on the sound signal and improve sound pickup accuracy, in this embodiment of this application, after the sound signal is obtained based on the directional microphone in the microphone array in the first step, the obtained sound signal is processed by using the VAD or the SPP, and the sound signal in the mute state is directly eliminated from the sound signal obtained by the directional microphone, accelerating extraction of the sound signal. In another possible implementation, as shown in FIG. 33, after the sound signal processing is completed, the processed sound signal may be processed by using the VAD or the SPP, to finally output the extracted sound signal. Certainly, the step of using the VAD or the SPP to eliminate the sound signal in the mute state may be flexibly adjusted based on different sound signal extraction methods or different adaptive scenarios. This is not limited in this application.

Certainly, in another possible implementation, noise reduction processing may be further performed on the original sound signal obtained by the directional microphone array by using at least one of the following methods: a beamformer, a generalized sidelobe canceller, a blind source separation technology, diffuse field noise suppression, a nonlinear beam, and a voice activity detection algorithm/speech presence probability algorithm, to obtain a noise-reduced sound signal. This is not limited in this application.

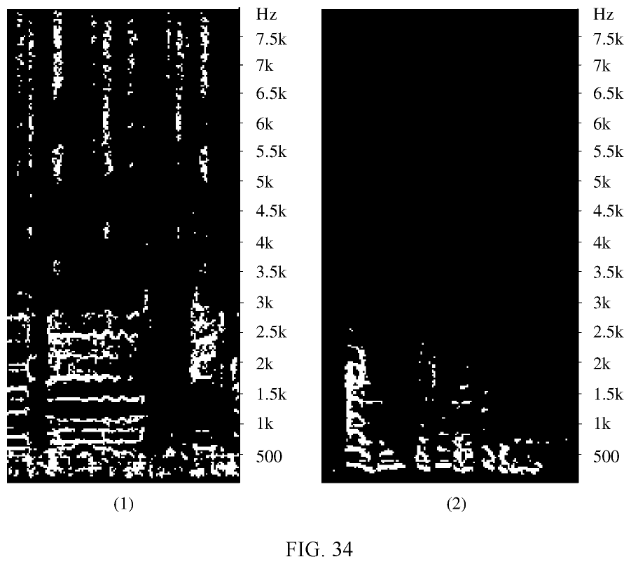

FIG. 34 is a diagram of comparison of effect of extracting a sound signal of a wearer in a same noise environment by using two methods according to an embodiment of this application. (1) in FIG. 34 is an effect diagram of extracting the sound signal of the wearer in the noise environment by using an existing method, and (2) in FIG. 34 is an effect diagram of extracting the sound signal of the wearer in the noise environment by using a noise reduction method provided in this application. It should be noted that, in the foregoing effect diagrams of extracting the sound signal, a horizontal coordinate indicates time (not shown in the figure), a vertical coordinate indicates a frequency, and a bright color in the figure indicates strength of sound signal energy at a time-frequency bin. A brighter color and a darker color of a background in the figure indicate a better sound extracted from a time-frequency bin, that is, indicate more obvious noise reduction effect on the sound signal. By comparing (1) and (2) in FIG. 34, it is not difficult to find that a harmonic of the sound signal of the wearer shown in (2) in FIG. 34 is more obvious when the sound signal of the wearer is extracted in the same noise environment. This also indicates that the noise reduction method provided in this application can effectively separate the sound signal of the wearer from noise, and provide better noise suppression effect.

In the noise reduction method provided in the foregoing embodiment, the sound signal obtained by the microphone array is first converted into a steering vector signal based on the target direction, so that a sound signal close to the target direction is separated from the sound signals of the plurality of channels collected by the directional microphone, laying a foundation for subsequent processing of the sound signal. Then, diffuse field noise suppression is performed on the sound signal, and the diffuse field noise from all the directions in the entire space is screened out from the sound signal, so that the sound signal obtained through diffuse field noise suppression is clearer. The sound signal is further processed through nonlinear filtering, to suppress the sound signal in the direction other than the target direction in the sound signal, implementing directional collection of the sound signal. Then, VAD/SPP processing is performed on the sound signal obtained by the directional microphone, to accelerate a noise reduction processing speed of the sound signal. In addition, post-filter and correlation processing are performed on the processed sound signal, to further screen out residual noise in the processed sound signal. This ensures sound quality of the finally obtained sound signal, and further improves a sound pickup signal-to-noise ratio.

In a possible implementation, after the sound signal corresponding to the target sound pickup direction is enhanced from the original sound signal based on the target sound pickup direction, to obtain the enhanced sound signal, spatial rendering processing may be further performed on the enhanced sound signal. The sound signal obtained through spatial rendering processing includes position information of the sound signal, so that the user can clearly distinguish a sound position by using two ears. A method for implementing spatial rendering effect includes but is not limited to an interaural time difference (ITD) method, or an interaural level difference (ILD) method.

Optionally, after the enhanced sound signal is obtained, the enhanced sound may be played by using the electronic device. For example, the enhanced sound is played by using a built-in speaker of the electronic device. Alternatively, the electronic device sends the enhanced sound signal to a playing device for play. For example, the enhanced sound may be played by using a stereo. Alternatively, the enhanced sound is stored by using the electronic device or the playing device.

Scenario 2: The method may be applied to an electronic device and a sound pickup device. The sound pickup device collects an original sound signal, and the electronic device sets a target sound pickup direction. The sound pickup device may be a mike, a two way radio, or the like, or may be the wearable device in the foregoing embodiment. The electronic device may be a mobile phone, a personal digital assistant, a tablet computer, a vehicle-mounted computer, a laptop computer, a smart screen, an ultra-mobile personal computer, a wearable device, or another device that can communicate with the sound pickup device. In this scenario, the electronic device may communicate with the sound pickup device by using a wireless communication technology (for example, a Bluetooth technology, an infrared and radio frequency technology, a 2.4G wireless technology, or an ultrasonic wave) or the like. For example, smart glasses are the sound pickup device, and the mobile phone is the electronic device. The smart glasses may communicate with the mobile phone by using the wireless communication technology. After the smart glasses are successfully connected to the mobile phone, the smart glasses and the mobile phone may perform the sound pickup method provided in this embodiment of this application.

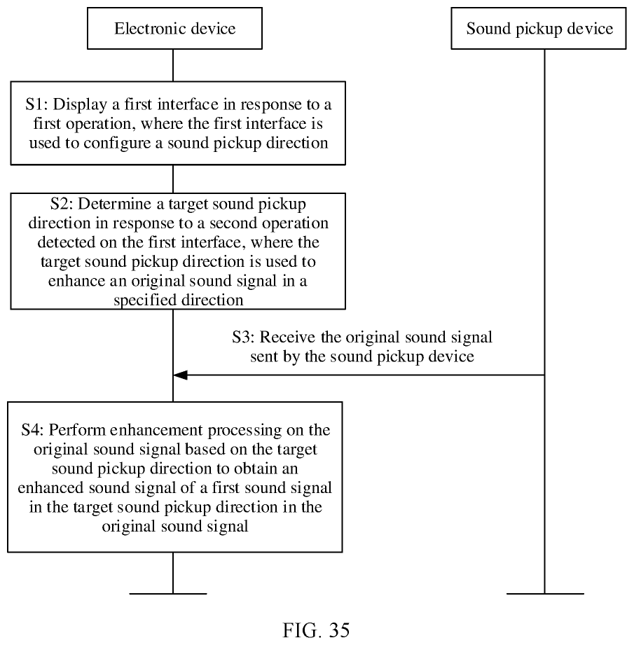

FIG. 35 is a schematic flowchart of another sound pickup method according to an embodiment of this application. Refer to FIG. 35. The sound pickup method includes the following steps.
S1: An electronic device displays a first interface in response to a first operation, where the first interface is used to configure a sound pickup direction.

In this embodiment of this application, the first operation may be a tap operation, a touch operation, or a slide operation that is entered by a user on a display of the electronic device, or a control operation that is entered by the user by using a physical button on the electronic device, or a mid-air gesture detected by the user by using a camera or another sensor of the electronic device.

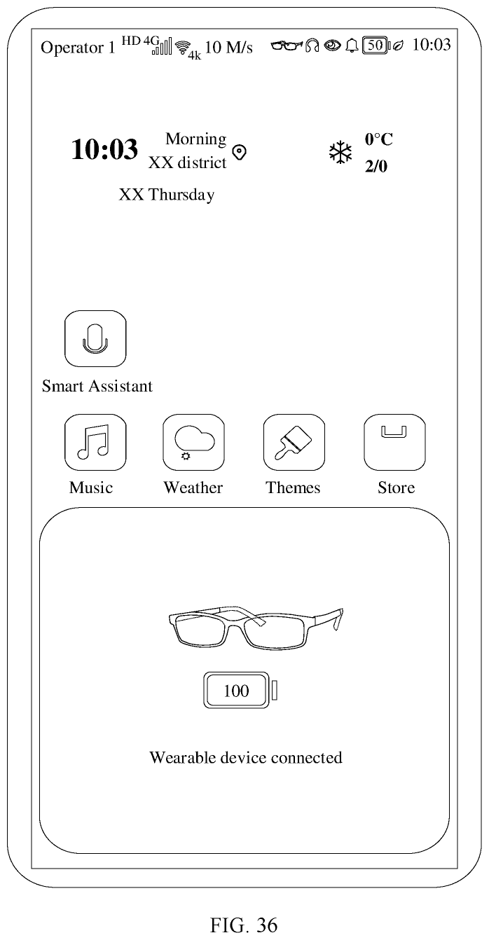

For example, refer to an interface displayed in FIG. 36. When the electronic device is connected to a sound pickup device, the electronic device may automatically display the first interface. The first operation is a connection operation or a configuration operation. Alternatively, when it is detected that the user taps a sound pickup settings key, the electronic device displays the first interface.

Optionally, for descriptions of other example embodiments of the first operation and related examples of the first interface, refer to the related descriptions in the foregoing scenario 1. Details are not described herein again.
S2: The electronic device determines a target sound pickup direction in response to a second operation detected on the first interface.

It should be understood that the target sound pickup direction is used to enhance an original sound signal in a specified direction. For details, refer to the descriptions of S2101 and S2102 in the foregoing scenario 1. Details are not described herein again.

It should be noted that, in this scenario, enhancement processing on the original sound signal may be performed by the electronic device or the sound pickup device.

For example, as shown in FIG. 35, after S1 and S2, a process in which the electronic device performs enhancement processing on the sound signal includes the following steps:
S3: The electronic device receives the original sound signal sent by the sound pickup device.
S4: The electronic device performs enhancement processing on the original sound signal based on the target sound pickup direction to obtain an enhanced sound signal of a first sound signal in the target sound pickup direction in the original sound signal.

For details, refer to the descriptions of S2103 and S2104 in the foregoing scenario

### 1. Details are not Described Herein Again.

After the enhanced sound signal is obtained, in another optional implementation, the enhanced sound may be played by using the electronic device. For example, the enhanced sound is played by using a built-in speaker of the electronic device. Alternatively, the electronic device sends the enhanced sound signal to a playing device for play. For example, the enhanced sound may be played by using a stereo. Alternatively, the enhanced sound is stored by using the electronic device or the playing device.

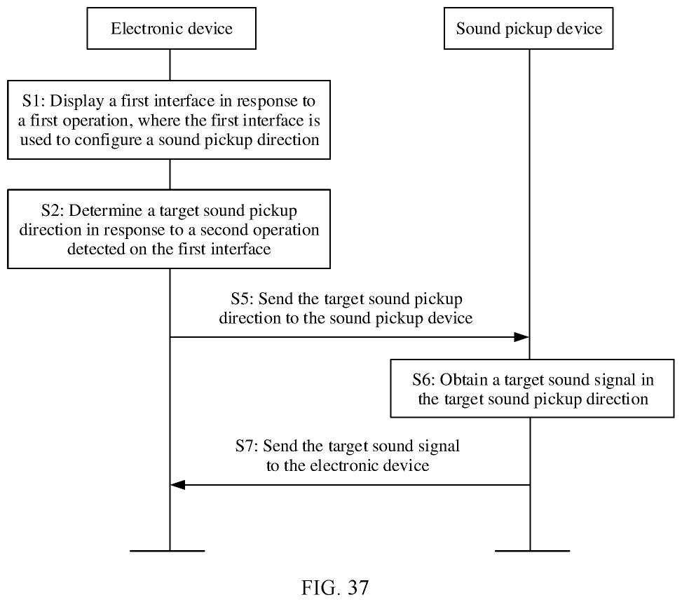

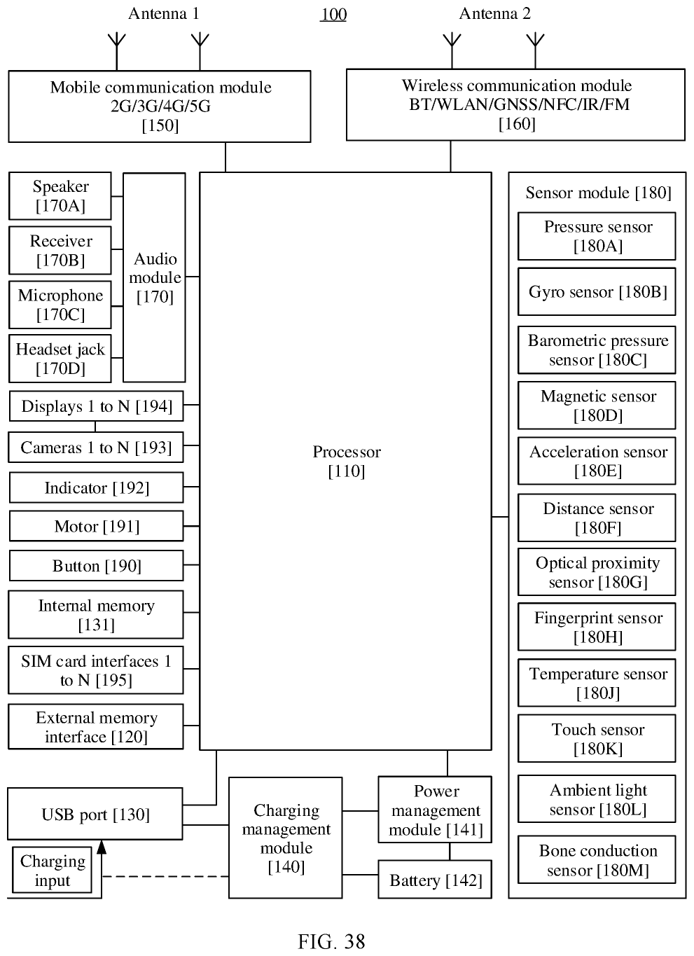

Optionally, the sound pickup device may further perform enhancement processing on the sound signal. Based on FIG. 35, refer to FIG. 37. After the foregoing steps S1 and S2, the sound pickup method may further include the following steps:
S5: The electronic device sends the target sound pickup direction to the sound pickup device.
S6: The sound pickup device obtains a target sound signal in the target sound pickup direction.

It should be understood that the obtained target sound signal may be a sound signal that is obtained through enhancement processing based on the target sound pickup direction; or may be a sound signal that is picked up based on an enabled microphone that points to the target sound pickup direction; or may be a sound signal that is obtained through enhancement processing based on enabled microphone that points to the target sound pickup direction.

After the sound pickup device receives the target sound pickup direction sent by the electronic device, the sound pickup device can directly pick up the target sound signal based on the target sound pickup direction in a subsequent sound pickup process, or perform signal enhancement processing on a picked-up original sound signal based on the target sound pickup direction to obtain a target sound signal in the target sound pickup direction in the original sound signal. This effectively improves a signal-to-noise ratio of the finally picked-up sound signal, and improves intelligibility of the sound signal and user experience.

In a possible implementation, step S6 in which the sound pickup device obtains the target sound signal in the target sound pickup direction may include the following steps:
S61: The sound pickup device collects the original sound signal.
S62: Perform enhancement processing on the original sound signal based on the target sound pickup direction to obtain an enhanced sound signal of a first sound signal in the target sound pickup direction in the original sound signal, where the enhanced sound signal is the target sound signal.

In this possible implementation, after the original sound signal is obtained, enhancement processing is performed on the original sound signal based on the target sound pickup direction, to obtain the enhanced sound signal corresponding to the target sound pickup direction. In this way, the target sound pickup direction may be flexibly adjusted based on different actual application scenarios, to obtain, through enhancement processing, the enhanced sound signal corresponding to the target sound pickup direction. In this case, the obtained sound signal does not mix with another omnidirectional sound signal, clarity of the target sound signal is improved, and sound quality of the target sound signal is improved.

In another possible implementation, step S6 in which the sound pickup device obtains the target sound signal in the target sound pickup direction may alternatively include the following steps.
S63: Enable, based on the target sound pickup direction, the microphone that points to the target sound pickup direction, and disabling a microphone that does not point to the target sound pickup direction.
S64: Collect the target sound signal by using the enabled microphone that points to the target sound pickup direction.

In this possible implementation, power consumption of the electronic device can be reduced, user experience is improved, and a service life of smart glasses is prolonged. In addition, the electronic device enables, based on the detected target sound pickup direction, the microphone that points to the target sound pickup direction, and disables another microphone. This can further prevent, as much as possible, the microphone from picking up noise in a direction other than the target sound pickup direction, and enhance sound pickup effect of the microphone. In actual application, different sound pickup effect can be further implemented by using an enabled state or a disabled state of each directional microphone.

Optionally, step S6 in which the sound pickup device obtains the target sound signal in the target sound pickup direction may alternatively include the following steps:
S65: Enable, based on the target sound pickup direction, the microphone that points to the target sound pickup direction, and disabling a microphone that does not point to the target sound pickup direction.
S66: Collect the original sound signal by using the enabled microphone that points to the target sound pickup direction.
S67: Perform enhancement processing on the original sound signal based on the target sound pickup direction to obtain an enhanced sound signal of a first sound signal in the target sound pickup direction in the original sound signal, where the enhanced sound signal is the target sound signal.

In this possible implementation, the sound pickup device enables, based on the target sound pickup direction, the microphone that points to the target sound pickup direction, and disables another microphone. This can prevent the microphone from picking up noise in a direction other than the target sound pickup direction, reduce obtained noise with relatively strong sound quality in the original sound signal, and enhance sound pickup effect of the microphone. Further, enhancement processing is performed on the sound signal obtained by the enabled directional microphone, to obtain the enhanced sound signal corresponding to the target sound pickup direction. In this case, the obtained sound signal does not mix with a sound signal in another direction, and clarity and sound quality of the enhanced sound signal are improved. This effectively improves a signal-to-noise ratio of the finally picked-up sound signal, and improves intelligibility of the sound signal and user experience.

For details, refer to the descriptions of the embodiment in which the electronic device obtains the sound signal in the foregoing scenario 1, and details are not described herein again.
S7: The sound pickup device sends the target sound signal to the electronic device.

Optionally, the target sound signal may be played by using the electronic device. For example, the target sound is played by using a built-in speaker of the electronic device. Alternatively, the electronic device sends the target sound signal to a playing device for play. For example, the target sound may be played by using a stereo. Alternatively, the target sound signal is stored by using the electronic device or the playing device.

It should be understood that, based on an actual application scenario, the sound pickup device may alternatively be a device in the foregoing electronic device. Certainly, the sound pickup device or the electronic device may alternatively be another future technology-oriented device. Specific types of the sound pickup device and the electronic device are not limited in this embodiment of this application.

The following describes an apparatus embodiment provided in this application. It should be understood that descriptions of apparatus embodiments correspond to the descriptions of the method embodiments. Therefore, for content that is not described in detail, refer to the foregoing method embodiments. For brevity, details are not described herein again.

FIG. 38 is a diagram of a structure of a device 100 according to this application. The device 100 includes the electronic device and the sound pickup device in the foregoing embodiments. As shown in FIG. 38, the device 100 may include a processor 110, an external memory interface 120, an internal memory 131, a universal serial bus (USB) port 130, a charging management module 140, a power management module 141, a battery 142, an antenna 1, an antenna 2, a mobile communication module 150, a wireless communication module 160, an audio module 170, a speaker 170A, a receiver 170B, a microphone 170C, a headset jack 170D, a sensor module 180, a button 190, a motor 191, an indicator 192, a camera 193, a display 194, a subscriber identity module (SIM) card interface 195, and the like. The sensor module 180 may include a pressure sensor 180A, a gyro sensor 180B, a barometric pressure sensor 180C, a magnetic sensor 180D, an acceleration sensor 180E, a distance sensor 180F, an optical proximity sensor 180G, a fingerprint sensor 180H, a temperature sensor 180J, a touch sensor 180K, an ambient light sensor 180L, a bone conduction sensor 180M, or the like.

It may be understood that the structure shown in this embodiment of this application does not constitute a specific limitation on the device 100. In some other embodiments of this application, the device 100 may include more or fewer components than those shown in the figure, or some components may be combined, or some components may be split, or a different component arrangement may be used. The components shown in the figure may be implemented by hardware, software, or a combination of software and hardware.

For example, when the device 100 is a mobile phone or a tablet computer, the device 100 may include all components in the figure, or may include only some components in the figure.

The processor 110 may include one or more processing units. For example, the processor 110 may include an application processor (AP), a modem processor, a graphics processing unit (GPU), an image signal processor (ISP), a controller, a memory, a video codec, a digital signal processor (DSP), a baseband processor, a neural network processing unit (NPU), and/or the like. Different processing units may be independent components, or may be integrated into one or more processors.

The controller may be a nerve center and a command center of the device 100. The controller may generate an operation control signal based on instruction operation code and a time sequence signal, to complete control of instruction fetching and instruction execution.

A memory may be further disposed in the processor 110, and is configured to store instructions and data. In some embodiments, the memory in the processor 110 is a cache memory. The memory may store instructions or data that has been recently used or cyclically used by the processor 110. If the processor 110 needs to use the instructions or data again, the processor 110 may directly call the instructions or data from the memory. This avoids repeated access, reduces waiting time of the processor 110, and improves system efficiency.

In some embodiments, the processor 110 may include one or more interfaces. The interface may include an inter-integrated circuit (I2C) interface, an inter-integrated circuit sound (I2S) interface, a pulse code modulation (PCM) interface, a universal asynchronous receiver/transmitter (UART) interface, a mobile industry processor interface (MIPI), a general-purpose input/output (GPIO) interface, a subscriber identity module (SIM) interface, a universal serial bus (USB) port, and/or the like.

The I2C interface is a bidirectional synchronous serial bus, including a serial data line (SDA) and a serial clock line (SCL). In some embodiments, the processor 110 may include a plurality of groups of I2C buses. The processor 110 may be separately coupled to the touch sensor 180K, a charger, a flash, the camera 193, and the like through different I2C bus interfaces. For example, the processor 110 may be coupled to the touch sensor 180K through the I2C interface, so that the processor 110 communicates with the touch sensor 180K through an I1C bus interface, to implement a touch function of the device 100.

The I1S interface may be used for audio communication. In some embodiments, the processor 110 may include a plurality of groups of I2S buses. The processor 110 may be coupled to the audio module 170 through the I1S bus to implement communication between the processor 110 and the audio module 170. In some embodiments, the audio module 170 may transmit an audio signal to the wireless communication module 160 through the I1S interface.

The PCM interface may also be used for audio communication, sampling, quantizing, and encoding an analog signal. In some embodiments, the audio module 170 and the wireless communication module 160 may be coupled through a PCM bus interface.

In some embodiments, the audio module 170 may alternatively transmit an audio signal to the wireless communication module 160 through the PCM interface. Both the I2S interface and the PCM interface may be used to perform audio communication.

The UART interface is a universal serial data bus used for asynchronous communication. The bus may be a bidirectional communication bus. The bus converts to-be-transmitted data between parallel communication.

In some embodiments, a UART interface is generally used to connect the processor 110 and the wireless communication module 160. For example, the processor 110 communicates with a Bluetooth module in the wireless communication module 160 through the UART interface, to implement a Bluetooth function. In some embodiments, the audio module 170 may transfer an audio signal to the wireless communication module 160 through the UART interface to implement a function of playing music through a Bluetooth headset.

The MIPI interface may be used to connect the processor 110 and peripheral components such as the display 194 and the camera 193. The MIPI interface includes a camera serial interface (CSI), a display serial interface (DSI), or the like. In some embodiments, the processor 110 communicates with the camera 193 through the CSI interface, to implement a photographing function of the device 100. The processor 110 communicates with the display 194 through the DSI interface, to implement a display function of the device 100.

The GPIO interface may be configured by software. The GPIO interface may be configured as a control signal or as a data signal. In some embodiments, the GPIO interface may be used to connect the camera 193, the display 194, the wireless communication module 160, the audio module 170, the sensor module 180, and the like to the processor 110. The GPIO interface may also be configured as an I2C interface, an I2S interface, a UART interface, an MIPI interface, or the like.

The USB port 130 is an interface conforming to the USB standard specification, and specifically, may be a Mini USB port, a Micro USB port, a USB type-C port, or the like. The USB port 130 may be used to be connected to the charger to charge the device 100, or may be used to transmit data between the device 100 and a peripheral device, or may be used to connect to a headset to play audio through the headset. The interface may be further used to connect to another device, like an AR device.

It may be understood that an interface connection relationship between the modules that is shown in this embodiment of this application is merely an example for description, and does not constitute a limitation on a structure of the device 100. In some other embodiments of this application, the device 100 may alternatively use an interface connection manner different from that in the foregoing embodiment, or use a combination of a plurality of interface connection manners.

The charging management module 140 is configured to receive a charging input from the charger. The charger may be a wireless charger or a wired charger. In some embodiments of wired charging, the charging management module 140 may receive a charging input of the wired charger through the USB port 130. In some embodiments of wireless charging, the charging management module 140 may receive a wireless charging input by using a wireless charging coil of the device 100. The charging management module 140 may further supply power to the device by using the power management module 141 while charging the battery 142.

The power management module 141 is configured to connect to the battery 142, the charging management module 140, and the processor 110. The power management module 141 receives input of the battery 142 and/or the charging management module 140, to supply power to the processor 110, the internal memory 131, an external memory interface 120, the display 194, the camera 193, the wireless communication module 160, and the like. The power management module 141 may be further configured to monitor parameters such as a battery capacity, a battery cycle count, and a battery health status (electric leakage or impedance).

In some other embodiments, the power management module 141 may alternatively be provided in the processor 110. In some other embodiments, the power management module 141 and the charging management module 140 may alternatively be provided in a same component.

A wireless communication function of the device 100 may be implemented through the antenna 1, the antenna 2, the mobile communication module 150, the wireless communication module 160, the modem processor, the baseband processor, and the like.

The antenna 1 and the antenna 2 are configured to transmit and receive an electromagnetic wave signal. Each antenna in the device 100 may be configured to cover one or more communication frequency bands. Different antennas may be multiplexed to improve antenna utilization. For example, the antenna 1 may be multiplexed as a diversity antenna in a wireless local area network. In some other embodiments, the antenna may be used in combination with a tuning switch.

The mobile communication module 150 may provide a wireless communication solution that is applied to the device 100, including 2G/3G/4G/5G and the like. The mobile communication module 150 may include at least one filter, a switch, a power amplifier, a low noise amplifier (LNA), and the like. The mobile communication module 150 may receive an electromagnetic wave through the antenna 1, perform processing such as filtering or amplification on the received electromagnetic wave, and transmit the electromagnetic wave to the modem processor for demodulation. The mobile communication module 150 may further amplify a signal modulated by the modem processor, and convert the signal into an electromagnetic wave for radiation through the antenna 1.

In some embodiments, at least some functional modules in the mobile communication module 150 may be disposed in the processor 110. In some embodiments, at least some functional modules of the mobile communication module 150 may be disposed in a same component as at least some modules of the processor 110.

The modem processor may include a modulator and a demodulator. The modulator is configured to modulate a to-be-sent low-frequency baseband signal into a medium/high-frequency signal. The demodulator is configured to demodulate a received electromagnetic wave signal into a low-frequency baseband signal. Then, the demodulator transmits the demodulated low-frequency baseband signal to the baseband processor for processing. The low-frequency baseband signal is processed by the baseband processor and then transmitted to the application processor. The application processor outputs a sound signal through an audio device (not limited to the speaker 170A, the receiver 170B, and the like), or displays an image or a video through the display 194. In some embodiments, the modem processor may be an independent component. In some other embodiments, the modem processor may be independent of the processor 110, and is disposed in a same component as the mobile communication module 150 or another functional module.

The wireless communication module 160 may provide a wireless communication solution that is applied to the device 100, and that includes a wireless local area network (WLAN) (for example, a wireless fidelity (Wi-Fi) network), Bluetooth (BT), a global navigation satellite system (GNSS), frequency modulation (FM), a near field communication (NFC) technology, an infrared (IR) technology, or the like. The wireless communication module 160 may be one or more components integrating at least one communication processing module. The wireless communication module 160 receives an electromagnetic wave through the antenna 2, performs frequency modulation and filtering processing on an electromagnetic wave signal, and sends a processed signal to the processor 110. The wireless communication module 160 may further receive a to-be-sent signal from the processor 110, perform frequency modulation and amplification on the signal, and convert the signal into an electromagnetic wave for radiation through the antenna 2.

In some embodiments, the antenna 1 and the mobile communication module 150 in the device 100 are coupled, and the antenna 2 and the wireless communication module 160 in the device 100 are coupled, so that the device 100 can communicate with a network and another device by using a wireless communication technology. The wireless communication technology may include a global system for mobile communication (GSM), a general packet radio service (GPRS), code division multiple access (CDMA), wideband code division multiple access (WCDMA), time-division code division multiple access (TD-SCDMA), long term evolution (LTE), BT, a GNSS, a WLAN, NFC, FM, an IR technology, and/or the like. The GNSS may include a global positioning system (GPS), a global navigation satellite system (GLONASS), a BeiDou navigation satellite system (BDS), a quasi-zenith satellite system (QZSS), and/or a satellite-based augmentation system (SBAS).

The device 100 implements a display function by using the GPU, the display 194, the application processor, and the like. The GPU is a microprocessor for image processing and is connected to the display 194 and the application processor. The GPU is configured to perform mathematical and geometric computation for graphic rendering. The processor 110 may include one or more GPUs that execute program instructions to generate or change display information.

The display 194 is configured to display an image, a video, and the like, for example, an icon, a folder, or a folder name of an app in this embodiment of this application. The display 194 includes a display panel. The display panel may be a liquid crystal display (LCD), an organic light-emitting diode (OLED), an active-matrix organic light-emitting diode (AMOLED), a flexible light-emitting diode (FLED), a mini-LED, a micro-LED, a micro-OLED, a quantum dot light-emitting diode (QLED), or the like. In some embodiments, the device 100 may include one or N displays 194. N is a positive integer greater than 1.

The device 100 may implement a photographing function by using the ISP, the camera 193, the video codec, the GPU, the display 194, the application processor, and the like.

The ISP may be configured to process data fed back by the camera 193. For example, during shooting, a shutter is pressed, and light is transmitted to a photosensitive element of the camera through a lens. The photosensitive element of the camera converts an optical signal into an electrical signal, and transmits the electrical signal to the ISP for processing, to convert the electrical signal into a visible image. The ISP may further perform algorithm optimization on noise, brightness, and complexion of the image. The ISP may further optimize parameters such as exposure and a color temperature of a photographing scenario. In some embodiments, the ISP may be disposed in the camera 193.

The camera 193 is configured to capture a still image or a video. An optical image of an object is generated through the lens, and is projected onto the photosensitive element. A focal length of a lens can be used to indicate a framing range of the camera. A smaller focal length of the lens indicates a larger framing range of the lens. The photosensitive element may be a charge-coupled device (CCD) or a complementary metal-oxide-semiconductor (CMOS) phototransistor. The photosensitive element converts an optical signal into an electrical signal, and then transmits the electrical signal to the ISP for converting the electrical signal into a digital image signal. The ISP outputs the digital image signal to the DSP for processing. The DSP converts the digital image signal into an image signal in a standard format like an RGB format or a YUV format.

In this application, the device 100 may include the camera 193 with two or more focal lengths.

The digital signal processor is configured to process a digital signal, and may process another digital signal in addition to the digital image signal. For example, when the device 100 selects a frequency bin, the digital signal processor is configured to perform Fourier transformation or the like on energy at the frequency bin.

The video codec is configured to compress or decompress a digital video. The device 100 may support one or more video codecs. In this way, the device 100 can play or record videos in a plurality of coding formats, for example, moving picture experts group (MPEG)-1, MPEG-1, MPEG-3, and MPEG-4.

The NPU is a neural-network (NN) computing processor. The NPU quickly processes input information by referring to a structure of a biological neural network, for example, a transfer mode between human brain neurons, and may further continuously perform self-learning. Applications such as intelligent cognition of the device 100 may be implemented through the NPU, for example, image recognition, facial recognition, speech recognition, and text understanding.

In this embodiment of this application, the NPU or another processor may be configured to perform an operation like analysis and processing on an image in a video stored in the device 100.

The external memory interface 120 may be used to connect to an external storage card, for example, a micro SD card, to extend a storage capability of the device 100. The external memory card communicates with the processor 110 through the external memory interface 120, to implement a data storage function. For example, files such as music and videos are stored in the external storage card.

The internal memory 131 may be configured to store computer-executable program code. The executable program code includes instructions. The processor 110 runs the instructions stored in the internal memory 131, to perform various function applications and data processing of the device 100. The internal memory 131 may include a program storage area and a data storage area. The program storage area may store an operating system, an application required by at least one function (for example, a sound playing function or an image playing function). The data storage area may store data (such as audio data and an address book) that are created during use of the device 100.

In addition, the internal memory 131 may include a high-speed random access memory, or may include a nonvolatile memory, for example, at least one magnetic disk storage device, a flash memory, or a universal flash storage (UFS).

The device 100 may implement an audio function, for example, music playing and recording, by using the audio module 170, the speaker 170A, the receiver 170B, the microphone 170C, the headset jack 170D, the application processor, and the like.

The audio module 170 is configured to convert a digital audio signal into an analog audio signal for output, and also configured to convert an analog audio input into a digital audio signal. The audio module 170 may be further configured to encode and decode an audio signal. In some embodiments, the audio module 170 may be disposed in the processor 110, or some functional modules of the audio module 170 are disposed in the processor 110.

The speaker 170A, also referred to as a “loudspeaker”, is configured to convert an electrical audio signal into a sound signal. The device 100 may be configured to listen to music or answer a hands-free call by using the speaker 170A. For example, the speaker may play a comparison analysis result provided in this embodiment of this application.

The receiver 170B, also referred to as an “earpiece”, is configured to convert an electrical audio signal into a sound signal. When a call is answered or a voice message is received through the device 100, the receiver 170B may be put close to a human ear to listen to a voice.

The microphone 170C, also referred to as a “mike” or a “mic”, is configured to convert a sound signal into an electrical signal. When making a call or sending a voice message, a user may make a sound near the microphone 170C through the mouth of the user, to input the sound signal to the microphone 170C. At least one microphone 170C may be disposed on the device 100. In some other embodiments, two microphones 170C may be disposed in the device 100, to collect a sound signal and further implement a noise reduction function. In some other embodiments, three, four, or more microphones 170C may alternatively be disposed in the device 100, to collect a sound signal, reduce noise, identify a sound source, implement a directional recording function, and the like.

The headset jack 170D is configured to connect to a wired headset. The headset jack 170D may be the USB port 130, or may be a 3.5 mm open mobile terminal platform (OMTP) standard interface, or a cellular telecommunications industry association of the USA (CTIA) standard interface.

The pressure sensor 180A is configured to sense a pressure signal, and convert the pressure signal into an electrical signal. In some embodiments, the pressure sensor 180A may be disposed on the display 194. There are a plurality of types of pressure sensors 180A, for example, a resistive pressure sensor, an inductive pressure sensor, and a capacitive pressure sensor. The capacitive pressure sensor may include at least two parallel plates made of conductive materials. When force is applied to the pressure sensor 180A, capacitance between electrodes changes. The device 100 determines pressure intensity based on a capacitance change. When a touch operation is performed on the display 194, the device 100 detects intensity of the touch operation by using the pressure sensor 180A. The device 100 may calculate a touch position based on a detection signal of the pressure sensor 180A.

In some embodiments, touch operations that are performed in a same touch position but have different touch operation intensity may correspond to different operation instructions. For example, when a touch operation whose touch operation intensity is less than a first pressure threshold is performed on a messaging application icon, an instruction for viewing an SME message is executed. When a touch operation whose touch operation intensity is greater than or equal to the first pressure threshold is performed on the messaging application icon, an instruction for creating a new SMS message is executed.

The gyro sensor 180B may be configured to determine a motion posture of the device 100. In some embodiments, angular velocities of device 100 around three axes (which are x, y, and z axes) may be determined by using the gyro sensor 180B. The gyro sensor 180B may be configured to implement image stabilization during photographing. For example, when the shutter is pressed, the gyro sensor 180B detects a shake angle of the device 100, and calculates, based on the angle, a distance for which a lens module needs to compensate, so that the lens counteracts the shake of the device 100 through reverse motion, implementing image stabilization. The gyro sensor 180B may also be used in a navigation scenario and a somatic game scenario.

The barometric pressure sensor 180C is configured to measure barometric pressure. In some embodiments, the device 100 calculates an altitude based on a value of the barometric pressure measured by the barometric pressure sensor 180C, to assist in positioning and navigation.

The magnetic sensor 180D includes a Hall sensor. The device 100 may detect opening and closing of a flip cover by using the magnetic sensor 180D. In some embodiments, when the device 100 is a flip device, the device 100 may detect opening and closing of flip by using the magnetic sensor 180D. Further, a feature, like automatic unlocking when the cover is flipped open, is set based on a detected opening or closing state of the leather case or a detected opening or closing state of the cover.

The acceleration sensor 180E may detect magnitudes of accelerations of the device 100 in all directions (usually on three axes). When the device 100 is still, a magnitude and a direction of gravity may be detected. The acceleration sensor 180E may be further configured to recognize a posture of the device, and is used in screen switching between a landscape mode and a portrait mode, a pedometer, or another application.

The distance sensor 180F is configured to measure a distance. The device 100 may measure a distance through infrared or laser. In some embodiments, in a photographing scenario, the device 100 may measure the distance by using the distance sensor 180F, to implement fast focusing.

The optical proximity sensor 180G may include, for example, a light-emitting diode (LED) and an optical detector, for example, a photodiode. The light-emitting diode may be an infrared light-emitting diode. The device 100 emits infrared light outward by using the light-emitting diode. The device 100 detects infrared reflected light from a nearby object by using the photodiode. When sufficient reflected light is detected, the device 100 may determine that there is an object near the device 100. When insufficient reflected light is detected, the device 100 may determine that there is no object near the device 100. The device 100 may use the optical proximity sensor 180G to detect that a user holds the device 100 close to an ear for a call, to automatically turn off the display screen to save power. The optical proximity sensor 180G may also be used in a leather case mode or a pocket mode to automatically unlock or lock the screen.

The ambient light sensor 180L is configured to sense luminance of ambient light. The device 100 may adaptively adjust brightness of the display 194 based on the sensed ambient light brightness. The ambient light sensor 180L may also be configured to automatically adjust white balance during shooting. The ambient light sensor 180L may further cooperate with the optical proximity sensor 180G to detect whether the device 100 is in a pocket, to avoid an unintentional touch.

The fingerprint sensor 180H is configured to collect a fingerprint. The device 100 may use a feature of the collected fingerprint to implement fingerprint-based unlocking, application lock access, fingerprint-based photographing, fingerprint-based call answering, and the like.

The temperature sensor 180J is configured to detect a temperature. In some embodiments, the device 100 executes a temperature processing policy by using the temperature detected by the temperature sensor 180J. For example, when the temperature reported by the temperature sensor 180J exceeds a threshold, the device 100 degrades performance of a processor near the temperature sensor 180J, to reduce power consumption for thermal protection. In some other embodiments, when the temperature is less than another threshold, the device 100 heats the battery 142 to avoid abnormal shutdown of the device 100 caused by a low temperature. In some other embodiments, when the temperature is less than still another threshold, the device 100 boosts an output voltage of the battery 142 to avoid abnormal shutdown caused by a low temperature.

The touch sensor 180K is also referred to as a “touch panel”. The touch sensor 180K may be disposed on the display 194, and the touch sensor 180K and the display 194 constitute a touchscreen, which is also referred to as a “touch screen”. The touch sensor 180K is configured to detect a touch operation on or near the touch sensor. The touch sensor may transfer the detected touch operation to the application processor to determine a type of a touch event. A visual output related to the touch operation may be provided on the display 194. In some other embodiments, the touch sensor 180K may alternatively be disposed on a surface of the device 100 at a position different from a position of the display 194.

The bone conduction sensor 180M may obtain a vibration signal. In some embodiments, the bone conduction sensor 180M may obtain a vibration signal of a vibration bone of a human vocal-cord part. The bone conduction sensor 180M may further be in contact with a human pulse and receive a blood pressure beating signal.

In some embodiments, the bone conduction sensor 180M may alternatively be disposed in the headset, to obtain a bone conduction headset. The audio module 170 may obtain a voice signal by parsing a vibration signal of a vibrating bone of a vocal-cord part obtained by the bone conduction sensor 180M, to implement a voice function. The application processor may parse heart rate information based on the blood pressure beating signal obtained by the bone conduction sensor 180M, to implement a heart rate detection function.

The button 190 includes a power button, a volume button, and the like. The button 190 may be a mechanical button, or may be a touch button. The device 100 may receive a button input, and generate a button signal input related to user settings and function control of the device 100.

The motor 191 may generate a vibration prompt. The motor 191 may be configured to produce an incoming call vibration prompt and a touch vibration feedback. For example, touch operations performed on different applications (for example, photographing and audio play) may correspond to different vibration feedback effect. For touch operations performed on different areas of the display 194, the motor 191 may also correspond to different vibration feedback effects. Different application scenarios (for example, a time reminder, information receiving, an alarm clock, and a game) may correspond to different vibration feedback effects. A touch vibration feedback effect may be further customized.

The indicator 192 may be an indicator light, and may be configured to indicate a charging status and a power change, or may be configured to indicate a message, a missed call, a notification, and the like.

The SIM card interface 195 is configured to connect a SIM card. The SIM card may be inserted into the SIM card interface 195 or pulled out of the SIM card interface 195, so that the SIM card is in contact with and separated from the device 100. The device 100 may support one or N SIM card interfaces, where N is a positive integer greater than 1. The SIM card interface 195 can support a nano-SIM card, a micro-SIM card, a SIM card, and the like. A plurality of cards may be simultaneously inserted into a same SIM card interface 195. The plurality of cards may be of a same type or different types. The SIM card interface 195 is compatible to different types of SIM cards. The SIM card interface 195 may also be compatible with an external storage card. The device 100 interacts with the network by using the SIM card, to implement a call function, a data communication function, and the like. In some embodiments, the device 100 uses an eSIM, namely, an embedded SIM card. The eSIM card may be embedded into the device 100, and cannot be separated from the device 100.

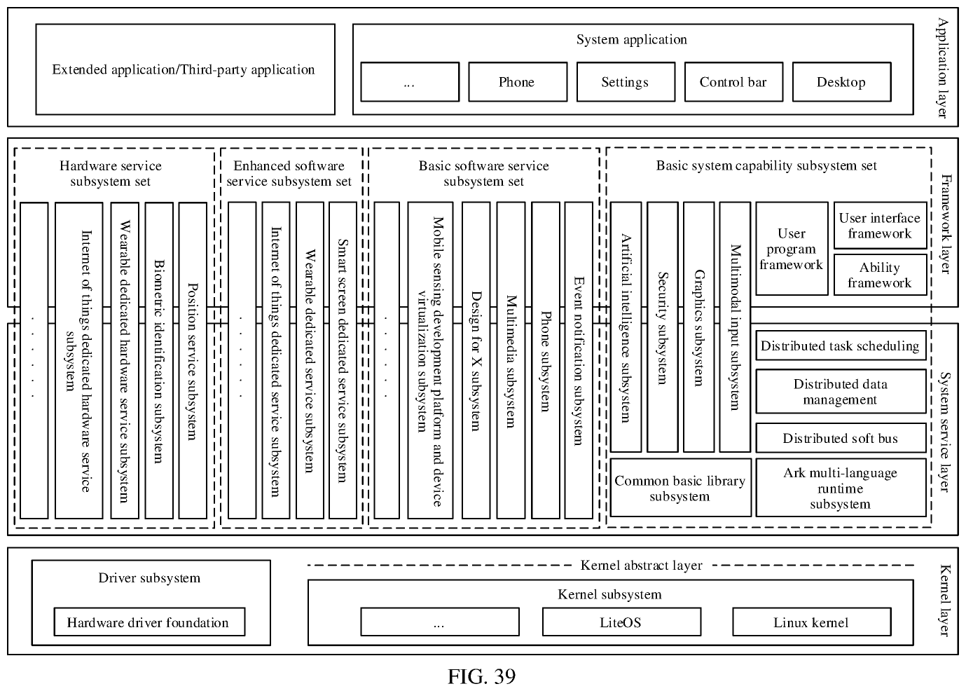

FIG. 39 is a diagram of a software structure of a device 100 according to an embodiment of this application. An operating system of the device 100 may be an Android system, a Microsoft windows system (Windows), an Apple mobile operating system (iOS), a HarmonyOS, or the like. Herein, an example in which the operating system of the device 100 is the HarmonyOS is used for description.

In some embodiments, the HarmonyOS may be divided into four layers, including a kernel layer, a system service layer, a framework layer, and an application layer. The layers communicate with each other through a software interface.

As shown in FIG. 39, the kernel layer includes a kernel abstract layer (KAL) and a driver subsystem. The KAL includes a plurality of kernels, for example, a Linux kernel of a Linux system and a lightweight internet of things system kernel LiteOS. The driver subsystem may include a hardware driver foundation (HDF). The hardware driver foundation provides an all-in-one framework of a peripheral access capability, driver development, and management. The multi-kernel kernel layer may select a corresponding kernel for processing based on a system requirement.

The system service layer is a core capability set of the HarmonyOS. The system service layer provides a service for an application through the framework layer. The layer may include a basic system capability subsystem set, a basic software service subsystem set, an enhanced software service subsystem set, and a hardware service subsystem set.

The basic system capability subsystem set provides basic capabilities for a distributed application to run, schedule, and migrate on a device running the HarmonyOS. The basic system capability subsystem set may include subsystems such as a distributed soft bus subsystem, a distributed data management subsystem, a distributed task scheduling subsystem, an Ark multi-language runtime subsystem, a common basic library subsystem, a multimodal input subsystem, a graphics subsystem, a security subsystem, an artificial intelligence (AI) subsystem, and a user program framework subsystem. The Ark multi-language runtime subsystem provides a C, C++, or JavaScript (JS) multi-language runtime and a basic system class library, and may further provide runtime for a Java program that is statically compiled by using an Ark compiler (namely, a part that is of the application or the framework layer and that is developed by using a Java language).

The basic software service subsystem set provides a common and universal software service for the HarmonyOS. The basic software service subsystem set may include subsystems such as an event notification subsystem, a telephone subsystem, a multimedia subsystem, a design for X (DFX) subsystem, and an MSDP&DV subsystem.

The enhanced software service subsystem set provides the HarmonyOS with differentiated and capability-enhanced software services for different devices. The enhanced software service subsystem set can include a smart screen dedicated service subsystem, a wearable dedicated service subsystem, and an internet of things (IoT) dedicated service subsystem.

The hardware service subsystem set provides a hardware service for the HarmonyOS. The hardware service subsystem set may include subsystems such as a position service subsystem, a biometric authentication subsystem, a wearable dedicated hardware service subsystem, and an IoT dedicated hardware service subsystem.

The framework layer provides a user program framework and ability framework for HarmonyOS application development in a plurality of languages, including Java, C, C++, and JS, two user interface (UI) frameworks (including a Java UI framework for the Java language and a JS UI framework for the JS language), and a multi-language framework application programming interface (API) for various software and hardware services. Supported APIs in a HarmonyOS device vary based on a degree of system componentization.

The application layer includes a system application and a third-party application (or referred to as an extended application). The system application may include an application that is installed by default on a device, like desktop, control bar, settings, and phone. The extended application may be an optional application developed and designed by a device manufacturer, for example, an application like device manager, device migration, notepad, or weather. The third-party non-system application may be an application that is developed by another vendor, but may be run in the HarmonyOS, for example, game, navigation, social media, or shopping.

The third-party non-system application provides a capability of running a task in a background and all-in-one data access abstraction. A PA mainly provides support for an FA, for example, provides a computing capability as a background service, or providing a data access capability as a data warehouse. An application developed based on the FA or PA can implement a specific service function, support cross-device scheduling and distribution, and provide consistent and efficient application experience for a user.

A plurality of devices running the HarmonyOS can implement hardware cooperation and resource sharing through a distributed soft bus, distributed device virtualization, distributed data management, and distributed task scheduling.

Based on the sound pickup method provided in the foregoing embodiments, embodiments of this application further provide the following content:

An embodiment provides a computer program product. The program product includes a program. When the program is run by an electronic device and/or a sound pickup device, the electronic device or the sound pickup device or both are enabled to perform the sound pickup methods shown in the foregoing embodiments.

An embodiment of this application provides a computer-readable storage medium. The computer-readable storage medium stores a computer program. When the computer program is executed by a processor, the sound pickup methods in the foregoing embodiments are performed.

An embodiment of this application provides a chip system. The chip system includes a memory and a processor. The processor executes a computer program stored in the memory, to control the foregoing electronic device to perform the sound pickup methods shown in the foregoing embodiments.

It should be understood that the processor in embodiments of this application may be a central processing unit (CPU), or may be another general-purpose processor, a digital signal processor (DSP), an application-specific integrated circuit (ASIC), a field programmable gate array (FPGA) or another programmable logic device, a discrete gate or transistor logic device, a discrete hardware component, or the like. The general-purpose processor may be a microprocessor, or any conventional processor.

It may be understood that the memory in embodiments of this application may be a volatile memory or a non-volatile memory, or may include a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), used as an external cache. Based on description used as an example instead of a limitation, many forms of RAMs may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM).

A person skilled in the art may clearly understand that for the purpose of convenient and brief description, division into the foregoing functional units or modules is merely used as an example for description. In actual application, the foregoing functions can be allocated to different functional units or modules for implementation based on a requirement. In other words, an inner structure of the apparatus is divided into different functional units or modules to implement all or some of the functions described above. The functional units or modules in embodiments may be integrated into one processing unit, each of the units may exist alone physically, or two or more units are integrated into one unit. The integrated unit may be implemented in a form of hardware, or may be implemented in a form of a software functional unit. In addition, a specific name of each of the function units or modules are merely for ease of distinguishing, but is not intended to limit the protection scope of this application. For a detailed working process of the foregoing units or modules in the foregoing system, refer to a corresponding process in the foregoing method embodiments. Details are not described herein again.

In the foregoing embodiments, the descriptions of each embodiment have respective focuses. For a part of an embodiment that is not described or explained in detail, refer to related descriptions of another embodiment.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

In embodiments provided in this application, it should be understood that the disclosed device and method may be implemented in other manners. For example, the described system embodiment is merely an example. For example, division into the units or modules is merely logical function division and may be other division in actual implementation. For example, a plurality of units or components may be combined or integrated into another system, or some features may be ignored or not performed. In addition, the displayed or discussed mutual coupling or direct coupling or communication connections may be implemented through some interfaces. The indirect coupling or communication connections between the apparatuses or units may be implemented in electrical, mechanical, or another form.

The units described as separate parts may or may not be physically separate, and parts displayed as units may or may not be physical units, may be located in one position, or may be distributed on a plurality of network units. Some or all of the units may be selected based on actual requirements to implement the purposes of the solutions of embodiments.

In addition, functional units in embodiments of this application may be integrated into one processing unit, each of the units may exist alone physically, or two or more units are integrated into one unit. The integrated unit may be implemented in a form of hardware, or may be implemented in a form of a software function unit.

When the integrated unit is implemented in the form of a software functional unit and sold or used as an independent product, the integrated unit may be stored in a computer-readable storage medium. Based on such an understanding, all or some of the procedures of the method in embodiments of this application may be implemented by a computer program instructing related hardware. The computer program may be stored in a computer-readable storage medium. When the computer program is executed by a processor, the steps in the foregoing method embodiments may be implemented. The computer program includes computer program code. The computer program code may be in a form of source code, object code, an executable file, in an intermediate form, or the like. The computer-readable medium may include at least any entity or apparatus that can carry the computer program code to a large-screen device, a recording medium, a computer memory, a read-only memory (ROM), a random access memory (RAM), an electrical carrier signal, a telecommunication signal, and a software distribution medium, for example, a USB flash drive, a removable hard disk, a magnetic disk, or an optical disc. In some jurisdictions, the computer-readable medium cannot be an electrical carrier signal or a telecommunication signal based on legislation and patent practices.

In conclusion, it should be noted that the foregoing descriptions are merely specific implementations of this application, but are not intended to limit the protection scope of this application. Any variation or replacement within the technical scope disclosed in this application shall fall within the protection scope of this application. Therefore, the protection scope of this application shall be subject to the protection scope of the claims.

1. A wearable device, wherein:
the wearable device comprises a microphone array, and the microphone array comprises at least one directional microphone; and
directions of sound pickup beams of the at least one directional microphone are orthogonal to each other.

2. The wearable device according to claim 1, wherein the microphone array further comprises at least one omnidirectional microphone.

3. The wearable device according to claim 1, wherein the wearable device is configured to: in response to at least detecting a target sound pickup direction, enable a first microphone that is in the microphone array and that points to the target sound pickup direction, and disable a second microphone that is in the microphone array and that does not point to the target sound pickup direction.

4. The wearable device according to claim 1, wherein the wearable device is configured to: in response to at least detecting that a first directional microphone that meets a preset condition exists in the microphone array, enable the first directional microphone, and disable a second directional microphone, wherein the preset condition is that signal quality of a sound signal picked up by the first directional microphone is higher than signal quality of a sound signal picked up by the second directional microphone in a preset time period.

5. The wearable device according to claim 1, wherein the wearable device is smart glasses.

6. The wearable device according to claim 5, wherein when the microphone array comprises one omnidirectional microphone, the omnidirectional microphone is located in a bridge or a nose pad of a rim of the smart glasses.

7. The wearable device according to claim 5, wherein when the microphone array comprises two omnidirectional microphones, the two omnidirectional microphones are respectively located on two temples of the smart glasses, or the two omnidirectional microphones are respectively located in positions that are on two sides of rims of the smart glasses and that are close to two temples.

8. The wearable device according to claim 5, wherein when the microphone array comprises more than two omnidirectional microphones, the more than two omnidirectional microphones are distributed in a middle area and two side areas of the smart glasses, the middle area comprises at least one of a) a bridge or b) nose pads of rims of the smart glasses, and the two side areas comprise at least one of a) two temples of the smart glasses or b) positions that are on two sides of the rims of the smart glasses and that are close to the two temples.

9. The wearable device according to claim 1, wherein the at least one directional microphone is a figure-8 microphone.

10. A sound pickup method, applied to a sound pickup device, wherein the method comprises:
receiving a target sound pickup direction sent by an electronic device; and
obtaining a target sound signal in the target sound pickup direction.

11. The method according to claim 10, wherein the obtaining a target sound signal in the target sound pickup direction comprises:
collecting an original sound signal; and
performing enhancement processing on the original sound signal based on the target sound pickup direction to obtain an enhanced sound signal of a first sound signal in the target sound pickup direction in the original sound signal, wherein the enhanced sound signal is the target sound signal.

12. The method according to claim 10, wherein the obtaining a target sound signal in the target sound pickup direction comprises:
enabling, based on the target sound pickup direction, a first microphone that points to the target sound pickup direction, and disabling a second microphone that does not point to the target sound pickup direction; and
collecting the target sound signal by using the enabled first microphone that points to the target sound pickup direction.

13. The method according to claim 10, wherein the obtaining a sound signal in the target sound pickup direction comprises:
enabling, based on the target sound pickup direction, a first microphone that points to the target sound pickup direction, and disabling a second microphone that does not point to the target sound pickup direction;
collecting an original sound signal by using the enabled first microphone that points to the target sound pickup direction; and
performing enhancement processing on the original sound signal based on the target sound pickup direction to obtain an enhanced sound signal of a first sound signal in the target sound pickup direction in the original sound signal, wherein the enhanced sound signal is the target sound signal.

14. The method according to claim 10, wherein the method further comprises: playing the target sound signal.

15. The method according to claim 10, wherein the method further comprises: sending the target sound signal to an audio playing device.

16. A computer-readable storage medium, wherein the computer-readable storage medium stores computer instructions for execution by a computer device to enable the computer device to perform:
receiving a target sound pickup direction sent by an electronic device; and
obtaining a target sound signal in the target sound pickup direction.

17. The computer-readable storage medium according to claim 16, wherein the obtaining a target sound signal in the target sound pickup direction comprises:
collecting an original sound signal; and
performing enhancement processing on the original sound signal based on the target sound pickup direction to obtain an enhanced sound signal of a first sound signal in the target sound pickup direction in the original sound signal, wherein the enhanced sound signal is the target sound signal.

18. The computer-readable storage medium according to claim 16, wherein the obtaining a target sound signal in the target sound pickup direction comprises:
enabling, based on the target sound pickup direction, a first microphone that points to the target sound pickup direction, and disabling a second microphone that does not point to the target sound pickup direction; and
collecting the target sound signal by using the enabled first microphone that points to the target sound pickup direction.

19. The computer-readable storage medium according to claim 16, wherein the obtaining a sound signal in the target sound pickup direction comprises:
enabling, based on the target sound pickup direction, a first microphone that points to the target sound pickup direction, and disabling a second microphone that does not point to the target sound pickup direction;
collecting an original sound signal by using the enabled first microphone that points to the target sound pickup direction; and
performing enhancement processing on the original sound signal based on the target sound pickup direction to obtain an enhanced sound signal of a first sound signal in the target sound pickup direction in the original sound signal, wherein the enhanced sound signal is the target sound signal.

20. The computer-readable storage medium according to claim 16, wherein the method further comprises: playing the target sound signal.
